(19) United States
(12) Patent Application Publication
(10) Pub. No.: US 2013/0315466 A1
(43) Pub. Date: Nov. 28, 2013

(54) AUTOMATED DETECTION, TRACKING AND ANALYSIS OF CELL MIGRATION IN A 3-D MATRIX SYSTEM

(71) Applicant: METAVI LABS INC., Austin, TX (US)

(72) Inventor: DAVID W. DRELL, AUSTIN, TX (US)

(73) Assignee: METAVI LABS INC., Austin, TX (US)

(21) Appl. No.: 13/888,905

(22) Filed: May 7, 2013

Related U.S. Application Data
(60) Provisional application No. 61/651,968, filed on May 25, 2012.

(51) Int. Cl. G06K 9/00

(52) U.S. Cl. CPC G06K 9/00127
USPC 382/133

(57) ABSTRACT

A data processing system receives an image of a matrix including a plurality of living cells. The data processing system automatically locates a cell among the plurality of living cells in the image by performing image processing on the image. In response to locating the cell, the data processing system records, in data storage, a position of the cell in the image. The data processing system may further automatically determine, based on the image, one or more selected metrics for the cell, such as one or more motility metrics, one or more frequency metrics and/or one or more morphology metrics. Based on the one or more metrics, the data processing system may further automatically determine a probability of success of a therapy on a patient employing a test substance and/or automatically select a treatment plan for recommendation.

### BACKGROUND OF THE INVENTION

The present invention relates to studying living cells, and more specifically, to automated detection, tracking and analysis of migration of living cells in a 3-D matrix system.

In the Western industrialized countries, cancer is the second leading cause of death. Although the primary tumor can often be removed by surgery and treated with various therapies, studies have shown that 90% of patients that die from the cancer do so from the development of metastases in other organs. Thus, there is an imminent need for the development of new drugs that especially target metastasis formation. In drug development, following the target discovery and lead generation phases, the Federal Drug Administration (FDA) and other national health authorities require that the potential new drug be tested using in vitro models, animals (in vivo studies) and in humans (clinical trials) for safety and efficacy. Current in vitro models focus on the cellular functions in tumor cells of cytotoxicity, proliferation, apoptosis, and angiogenesis, but are inadequate for the screening of the anti-migratory or anti-metastatic capacity of tumor cells. Therefore, potential therapeutic agents for the prophylaxis or treatment of metastasis formation remain undiscovered. In a draft guideline on the evaluation of anticancer medicinal products in man issued in December, 2011, the European Medicines Agency stated:
A very large number of anti-cancer compounds have been and currently are under development. Only a minority, however, have completed the clinical development and obtained a marketing authorization, due to insufficient evidence of efficacy or evidence of a detrimental safety profile. Until non-clinical models with good predictive properties have been defined, this situation is likely to remain essentially unchanged and the absence of such models is considered to constitute the greatest hurdle for efficient drug development within the foreseeable future.

The oldest model systems for investigating tumor cell migration are two-dimensional (2-D) model systems, in which tumor cells migrate on the flat glass or plastic surface of a microscope slide. In these 2-D model systems, the tumor cells are either placed directly on the glass or plastic surface or on a glass or plastic surface coated with a matrix substance, for example, fibronectin, laminin, collagen type I, collagen type IV, etc. However, placing tumor cells on a flat surface such as glass or plastic causes the tumor cells to elongate and deform from their in vivo shape, as shown for tumor cell 100 of FIG. 1A. Because such conditions do not exist in vivo, the useful information that can be gained by these assays is limited. Further, in many cases, such 2-D model systems lack collagen protein fibers, such as the collagen protein fibers 104 shown in the confocal microscopy photograph of a tumor cell 102 given in FIG. 1B. If these collagen protein fibers, which provide the cells' natural means of locomotion, are absent, little useful information can be gathered from the 2-D model system regarding the in vivo migration of a cell. Moreover, the use of 2-D assays can even lead to the development of artifacts, such as “stress fibers” of actin, that do not exist in vivo.

The observational analyses in 2-D assays are customarily “endpoint” counts. That is, the locations of the tumor cells at the beginning of the assay are not assessed, but rather the aggregate number of tumor cells that have reached a specific endpoint at the end of the observational time. This endpoint may be at the bottom of a cell-plate well or another predetermined observation point, such as the end of the microscopic slide or glass capillary tube. The duration of the observational period can be from several hours to up to five days.

Boyden assays, trans-well assays and filter assays are the most common commercially available 2-D assays for observing and measuring tumor cell migration, and many thousands of publications have been made using these assays. These 2-D assays are based on the migration of leukocytes or tumor cells through a filter having holes (pores) small enough to prevent the cells from falling through, for example, under the influence of gravity. These filters can be coated with any number of substances or other cells, including epithelial cells, to observe cell-cell interactions. These assays are also end-point assays in that the aggregate number of cells that pass through the pores is determined and compared to the relatively large number of cells that were inserted into the assay at the beginning. The most noteworthy disadvantage of filter assays is that, of the large number of cells typically applied, only a small fraction (e.g., 10%), representing the migratory active population of cells, is analyzed.

In addition to conventional 2-D endpoint assays, cell migration studies have also been performed via manual cell tracking In these cell migration studies, a video camera is affixed to the microscope, and a four to twelve hour time-lapse recording is made, with the duration selected based on the anticipated migration rate of the particular cell type. Following the conclusion of the recording, a human technician reviews the recording with the aid of a software program that allows the user to advance the recording frame-by-frame and to mark the locations of individual cells as they migrate over time. The software tracks the changes in the cells' positions noted by the technician. Using this manual method of tracking cell migration, a human user can manually annotate and approximate the migration of about 30 individual cells with about one hour of labor. Considering a typical substance assay requires recordings of up to six collagen-cell-substance wells, approximately six hours of labor are required to track cell migration for the assay. Typically, an experiment is performed three times for validation, meaning that eighteen hours of labor are required for a single experiment.

In view of the inherent limitations of conventional 2-D model systems and cell migration studies employing manual cell tracking, the present invention appreciates that it would be desirable to provide a automated detection, tracking and analysis of cell migration in a 3-D matrix system that models in vivo conditions.

### BRIEF SUMMARY

In some embodiments, a data processing system receives an image of a matrix including a plurality of living cells. The data processing system automatically locates a cell among the plurality of living cells in the image by performing image processing on the image. In response to locating the cell, the data processing system records, in data storage, a position of the cell in the image. The data processing system may further automatically determine, based on the image, one or more selected metrics for the cell, such as one or more motility metrics, one or more frequency metrics and/or one or more morphology metrics. Based on the one or more metrics, the data processing system may further automatically determine a probability of success of a therapy on a patient employing a test substance and/or automatically select a treatment plan for recommendation.

### BRIEF DESCRIPTION OF THE SEVERAL VIEWS OF THE DRAWINGS

FIG. 1A illustrates an elongated tumor cell resting on a substrate of a two-dimensional (2-D) model system;

FIG. 1B is a confocal microscopy photograph of a tumor cell in a 3-D collagen matrix;

FIG. 2A depicts an first exemplary embodiment of a microscope;

FIG. 2B depicts a second exemplary embodiment of a microscope;

FIG. 3 is a high level block diagram of an exemplary data processing system;

FIG. 4A illustrates a first embodiment of a cell migration chamber;

FIG. 4B depicts a second embodiment of cell migration chamber;

FIG. 5 illustrates a vertical section of an exemplary migration chamber as visualized by a microscope;

FIG. 6 depicts an image of living human pancreatic tumor cells in a 3-D collagen matrix as captured by a digital camera of a microscope;

FIG. 7 is a high level logical flowchart of an exemplary process by which image processing tool processes a reference frame of a video sequence.

FIG. 8 depicts exemplary data structures utilized to track cells between frames of a video sequence;

FIG. 9 illustrates data structures created or referenced in the identification of cells in a reference frame of a video sequence;

FIG. 10 depicts a high level logical flowchart of an exemplary process for creating a thresholded sharpened image;

FIG. 11 is an exemplary visualization of Laplacian matrix derived from the image of FIG. 6;

FIG. 12 is an exemplary visualization of a thresholded sharpened image derived from the image of FIG. 6;

FIG. 13, there is illustrated a process flow diagram of an exemplary process by which an image processing tool locates and extracts as blobs cells that are slightly out-of-focus in an image;

FIG. 14 is a visualization of a circle map in which the dark areas indicate strong circle spatial filter correlations and lighter areas represent lower correlation values;

FIG. 15 is a visualization of a flood fill map after slightly out-of-focus cells (ghosts) have been marked by the blobbing process;

FIG. 16 depicts an process flow diagram of an exemplary process by which an image processing tool locates and extracts black disks from a reference frame;

FIG. 17 is a visualization of circle map in which white patches represent the former locations of eliminated ghosts, dark areas indicate strong circle spatial filter correlations for in-focus cells, and lighter gray areas represent lower correlation values;

FIG. 18 is a visualization of a flood fill map after in-focus cells (black disks) and slightly out-of-focus cells (ghosts) have been marked by the blobbing process;

FIG. 19 is a high level logical flowchart of an exemplary process by which an image processing tool processes frames subsequent to the reference frame in a video sequence;

FIG. 20 is a process flow diagram of an exemplary process by which an image processing tool locates in and extracts from a subsequent frame carry-over blobs that appeared in a previous frame of a video sequence;

FIG. 21 is a process flow diagram of an exemplary process by which an image processing tool locates and extracts newly appearing ghosts from a subsequent frame following the reference frame in a video sequence;

FIG. 22 is a process flow diagram of an exemplary process by which an image processing tool locates and extracts newly appearing black disks from a frame subsequent to the reference frame of a video sequence;

FIG. 23 is a high level logical flowchart of an exemplary process by which an image processing tool finds cell locations by correlating image samples with circle spatial filters;

FIG. 24 is a high level logical flowchart of an exemplary process by which an image processing tool finds the best match in a subsequent frame of a blob from a preceding frame;

FIG. 25 is a high level logical flowchart of an exemplary blobbing process that may be employed by an image processing tool;

FIG. 26 depicts a visualization of cells in a 2-D focal plane of a 3-D matrix that can be output by IARV tool 316;

FIG. 27 illustrates a high level logical flowchart of an exemplary method by which an image processing tool captures images of a given specimen at multiple Z offsets at a given time sample; and

FIG. 28 depicts a high level logical flowchart of an exemplary method by which an image processing tool determines the Z position for each cell located in one or more images of a given specimen taken at a given sample time.

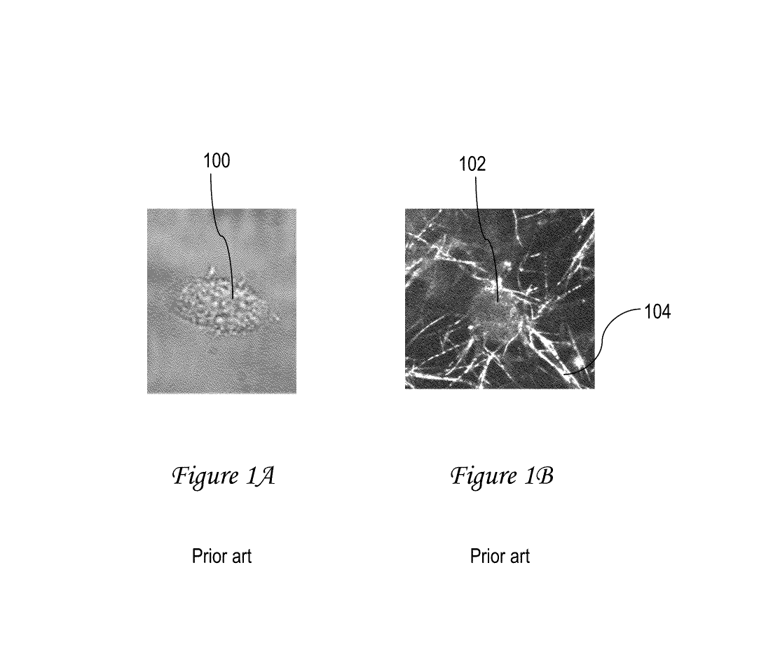

### DETAILED DESCRIPTION

Disclosed herein are systems, methods and program products for automatically detecting, tracking and analyzing migration of living cells in two or three spatial dimensions and through time, and are consequently referred to herein as enabling 4-D detection, tracking and analysis of cell migration. The cells that are the subject of study can be any type of cells of interest, including, without limitation, cancer cells, leukocytes, stem cells, fibroblasts, natural killer (NK) cells, macrophages, T lymphocytes (CD4⁺ and CD8⁺), B lymphocytes, adult stem cells, dendritic cells, any subtype of professional Antigen presenting cells (pAPC), neutrophil, basophil and eosinophil granulocytes, or and other animal cells. If the cells of interest are tumor cells, such tumor cells can be derived from commercially available and established tumor cell lines, modified tumor cell lines (e.g., knock-out, knock-in cell lines) or from fresh tumor tissue from a patient. In the following discussion the term “exemplary” should be construed as identifying one example of a process, system, structure or feature, but not necessarily the best, preferred or only process, system structure or feature that could be employed.

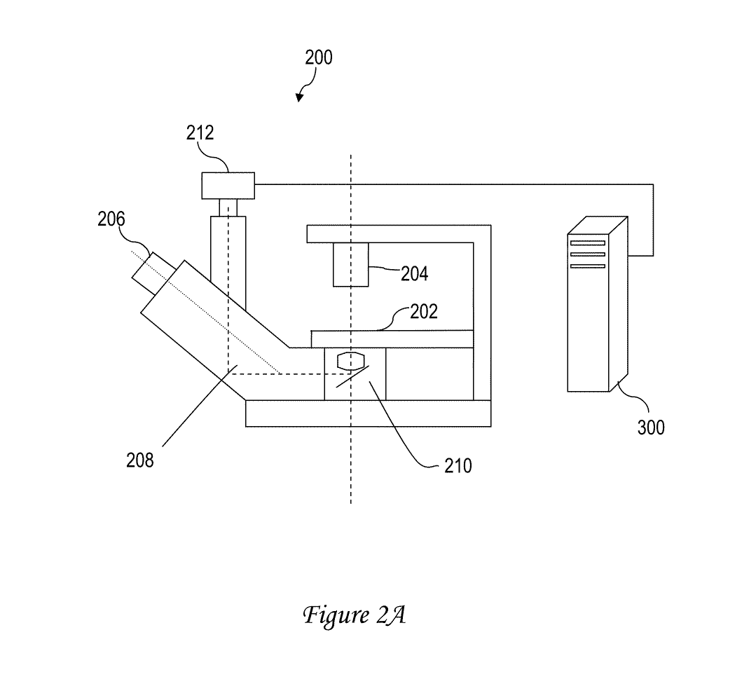

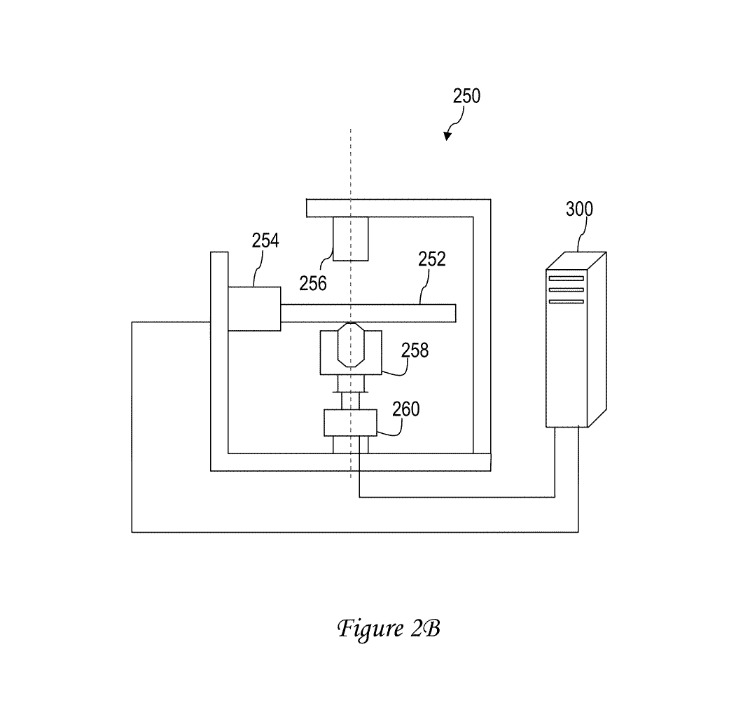

With reference again to the figures and, in particular, with reference to FIG. 2A, there is illustrated a schematic diagram of a first exemplary microscope 200 that can be employed in one or more embodiments. As shown, microscope 200 includes a specimen stage 202 and a light source 204 for illuminating specimen placed on specimen stage 202. Specimen stage 202 may be fixed or may be a motorized stage permitting precision control of position along the X, Y and Z axes. Light source 206 can, for example, emit light across a spectrum of wavelengths (e.g., the visible spectrum or infrared spectrum) or can be restricted to a specific wavelength (e.g., laser light). Microscope 200 further includes an ocular lens and view portal 206 through which a human user may observe a specimen placed on specimen stage 202, a prism 208 within the view portal, an objective lens and prism 210, and a digital camera 212 that captures video and/or still images of the specimen for the duration of an assay. As further indicated in FIG. 2, the video and/or still images captured by digital camera 202 over time can be transmitted (via a cable or wirelessly) to a data processing system, such as data processing system 300, for recording and analysis.

Referring now to FIG. 2B, there is depicted a schematic diagram of a second exemplary microscope 250 that can be employed in one or more embodiments. Microscope 250 is a minimal microscope optimized for automated processing of specimen (e.g., through robotic loading of specimen plates), support for multiple specimens per microscope, and precise temperature control of the specimen. Microscope 250 includes a specimen stage 252 designed to concurrently hold multiple wells (e.g., a 24-well, 96-well or 384-well plate or multiple such well plates). Specimen stage 252 preferably includes integrated temperature regulation to maintain a target temperature (e.g., 37 ° C.) for incubation of the specimen. A motor pack 254, which may contain, for example, separate X, Y and Z axis motors and a motor controller, provides precision control of the position of specimen stage 302 along the X, Y and Z axes. As shown in FIG. 2B, in some embodiments a data processing system 300 is further communicatively coupled (e.g., wirelessly or by a cable) to motor pack 254 to permit automated control of the position of specimen stage 252. A light source 256 illuminates specimen placed on specimen stage 252. Microscope 250 further includes an objective lens 258 and a digital camera 260 that captures video and/or still images of the specimen for the duration of an assay. Again, digital camera 260 is communicatively coupled (e.g., wirelessly or by a cable) to data processing system 300 for recording and analysis of the images captured by digital camera 260.

Commercially available digital video or still cameras can be employed for digital cameras 212 and 260. The resolution of cameras 212 or 260 can vary greatly between embodiments without significant effect on experimental results. However, higher resolutions enable greater field-of-view while providing sufficient resolution to track individual cell morphology. Resolutions as low as 640×480 pixels have been experimentally demonstrated, and higher resolutions such as 2048×2048 pixels have been found to provide excellent results. The images output by digital camera 212 or 260 are preferably uncompressed, but compressed images have also been successfully employed.

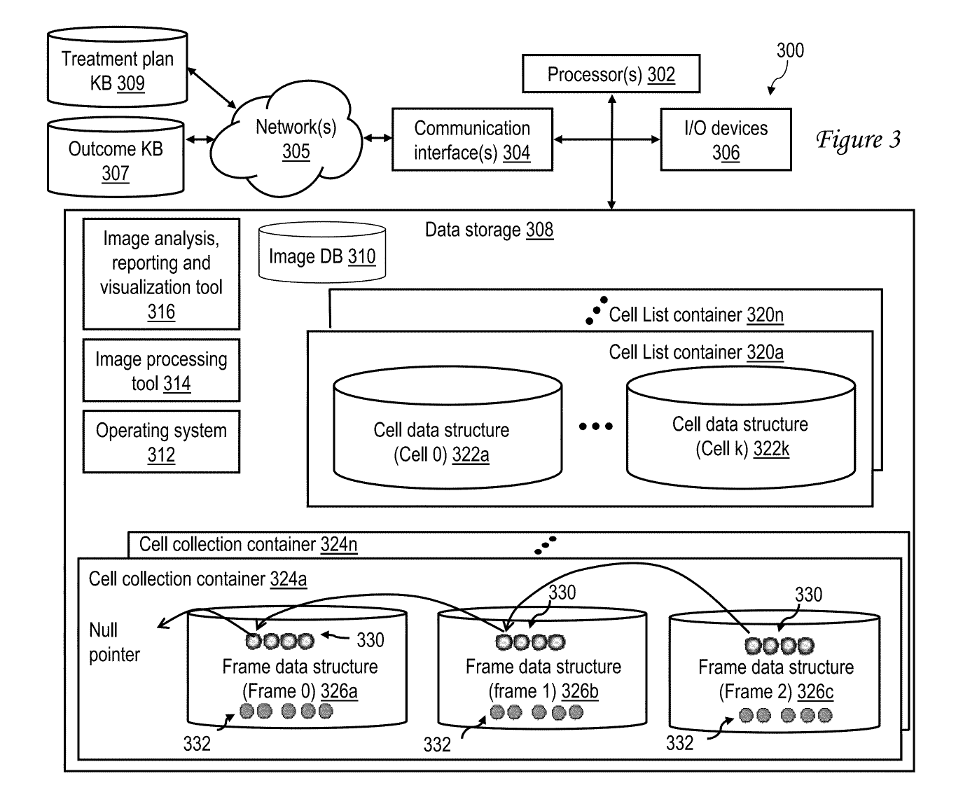

Referring now to FIG. 3, there is depicted a high level block diagram of an exemplary embodiment of a data processing system 300 as previously shown in FIG. 2A-2B. In various embodiments, a data processing system 300 can be implemented locally or remotely with respect to a microscope that captures images of a specimen, and one data processing system 300 can support one or more microscopes 200 and/or 250. Data processing system 300 can be implemented with commercially available hardware and is not limited to any specific hardware or software, except as may be necessitated by particular embodiments.

Data processing system 300 may include one or more processors 302 that process data and program code. Computer 300 additionally includes one or more communication interfaces 304 through which data processing system 300 can communicate with one or more microscopes 200 and/or 250 via cabling and/or one or more wired and/or wireless, public and/or private, local and/or wide area networks 305 (optionally including the Internet). The communication protocol employed for communication between a microscope 200 or 250 and data processing system 300 is arbitrary and may be any known or future developed communication protocol, for example, TCP/IP, Ethernet, USB, Firewire, 802.11, Bluetooth or any other protocol suitable for the selected the digital camera 212 or 260, motor pack 254 and data processing system 300.

Data processing system 300 also includes input/output (I/O) devices 306, such as ports, display devices, and attached devices, etc., which receive inputs and provide outputs of the processing performed by data processing system 300. Finally, data processing system 300 includes or is coupled to data storage 308, which may include one or more volatile or non-volatile storage devices, including memories, solid state drives, optical or magnetic disk drives, tape drives, portable data storage media, etc.

In the illustrated embodiment, data storage 308 stores various program code and data processed by processor(s) 302. The program code stored within data storage 308 includes an operating system 312 (e.g., Windows®, Unix®, AIX®, Linux®, Android®, etc.) that manages the resources of data processing system 300 and provides basic services for other hardware and software of data processing system 300. In addition, the program code stored within data storage 308 includes image processing tool 314 that, inter alia, processes image data 310 to track motility of cells (e.g., cancer cells, leukocytes, stem cells or other cells) in a 3-D matrix. Image processing tool 314 can be written utilizing any of a variety of known or future developed programming languages, including without limitation C, C#, C++, Objective C, Java, assembly, etc. Additional embodiments could alternatively or additionally utilize specialized programming instruction sets to harness the processing capability of graphics processing cards and vector math processors. In alternative embodiments, the functions of image processing tool 314 can be implemented in firmware or hardware (e.g., an FPGA), as is known in the art.

Although in some embodiments its functionality can optionally be incorporated within image processing tool 314, an image analysis, reporting and visualization (IARV) tool 316 can be separately implemented to provide automated analysis, reporting and visualization of the data (including images) processed and output by image processing tool 314, as discussed further below. As with image processing tool 314, IARV tool 316 can be written utilizing any of a variety of known or future developed programming languages, including without limitation C, C#, C++, Objective C, Java, assembly, etc.

The data held in data storage 308 includes an image database 310 of images captured by one or more microscopes 200 or 250. A photographic image captured and processed in accordance with the techniques disclosed herein may be a still image or video frame. In either case, each image or frame (the terms are generally utilized interchangeably herein) belongs to a video sequence, which is defined as a time-sequenced set of multiple images (frames) at a single focal plane. From a given specimen, the camera may capture images from as few as one focal plane or as many as allowed by the depth of a section of the 3-D matrix orthogonal to the focal planes (the typical resolution is 20 micrometers, but this resolution can be varied). Thus, if the digital camera 212, 260 captures images at, for example, ten focal planes in a given 3-D matrix, ten corresponding video sequences for that given 3-D matrix will be recorded in image database 310. The images can be processed prior to or immediately after storage in image database 310 (e.g., in real time or near real time) or at any time thereafter.

In addition to image database 310, data storage 308 may include additional data structures established by image processing tool 314 and/or IARV tool 316. In the depicted embodiment, these data structures include a respective cell list container 320a-320n for each video sequence. Each cell list container 320 includes cell data structures, such as exemplary cell data structures 322a through 322k. Each cell data structure 322 contains per-frame data associated with an individual cell, including the cell's position, shape, size, etc. The data structures within data storage 308 can additionally include a respective one of cell collection containers 324a-324n per video sequence. Each cell collection container 324 includes a respective frame data structure, such as frame data structures 326a, 326b and 326c, for each frame in a video sequence. Each frame data structure 326 contain collections of information, regarding images of cells (blobs) 330, 332 found in the associated frame. The relative chronological sequence of the frames comprising the video sequence are also maintained, for example, by a list of pointers represented in FIG. 3 by arrows linking frame data structures 326. These or other indications of frame sequence also associate blobs that have been tracked from frame-to-frame, indicating continual observance of a single living cell. From the data retained in data storage 308, additional cell tracking data and cell morphology data can be extracted, and if desired, stored and/or presented to a user.

To prepare a sample of living cells of interest for a 3-D assay, the cells of interest are introduced into a 3-D matrix that approximates the in vivo environment. For example, for a 3-D assay of mammalian cells, cells of interest are embedded within a three-dimensional matrix, such as fibronectin, laminin, collagen type I, collagen type IV or a combination of one or more of the foregoing materials. The 3-D matrix completely surrounds the cells, so that the cells do not contact an artificial, non-organic structure, such as glass or plastic. The cells are then able to move about using the protein fibers of the 3-D matrix in a manner similar to in vivo conditions. For example, a 3-D matrix can be prepared as 50 μl cell suspensions that are mixed with 100 μl of a buffered collagen solution (pH 7.4), containing 1.67 mg/ml bovine collagen type I and the remainder being collagen type IV.

While many video-microscopy applications chemically attach phosphorescent molecules to cellular structures under study to facilitate tracking, an advantage of the disclosed techniques is that phosphorescing tags are not required and preferably are not used. Drawbacks of using these phosphorescing tags include: 1) chemical alternation of the tagged cells by the phosphorescing tags and 2) the requirement that highly specialized low light sensitive cameras and complex microscope setups be used. Because the cells under study utilizing the techniques disclosed herein are preferably not stained and are thus untagged, simple transmission illumination with visible light and commonly available lens and camera technology can be employed in microscopes 200, 250.

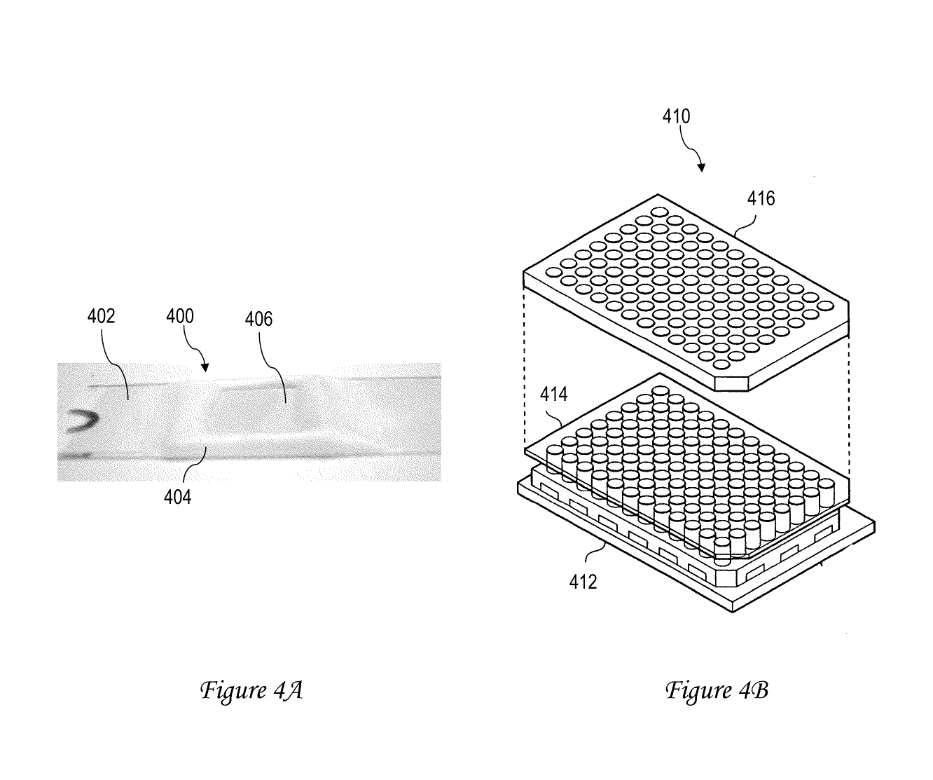

After polymerization of the 3-D matrix, for example, at 37° C. in a humidified 5% CO₂ atmosphere, the cell-matrix mixture, or if an additional substance is to be assayed, a cell-matrix-substance mixture, is then placed in a migration chamber (e.g., well) to enable migration of the cells to be captured by a digital camera 212 or 260. FIG. 4A illustrates a first exemplary well 400 that can be used as a migration chamber for a 3-D assay. Well 400 includes a microscopic glass or plastic slide 402, wax side walls 404 defining a generally rectangular well, and a cover slip 406 on top, resulting in a chamber with a surface area of about 400 mm², a height of 1 mm, and accordingly a volume of approximately 400 μl.

FIG. 4B depicts a second embodiment of migration chambers that may be utilized as for a 3-D assay. In this embodiment, the migration chambers are formed in a conventional 96-well plate 410, including a base 412, a grid of cylindrical wells 414, and a cover 416. Well plate 410 may be formed of a variety of materials, including PO plastic, PVC plastic or glass. The maximum working volume of a 96-well plate is approximately 300 μl. Of course, depending on the number of substances to the tested and the number of experiments per substance, different assays may utilize well plates having different numbers of wells and different capacities.

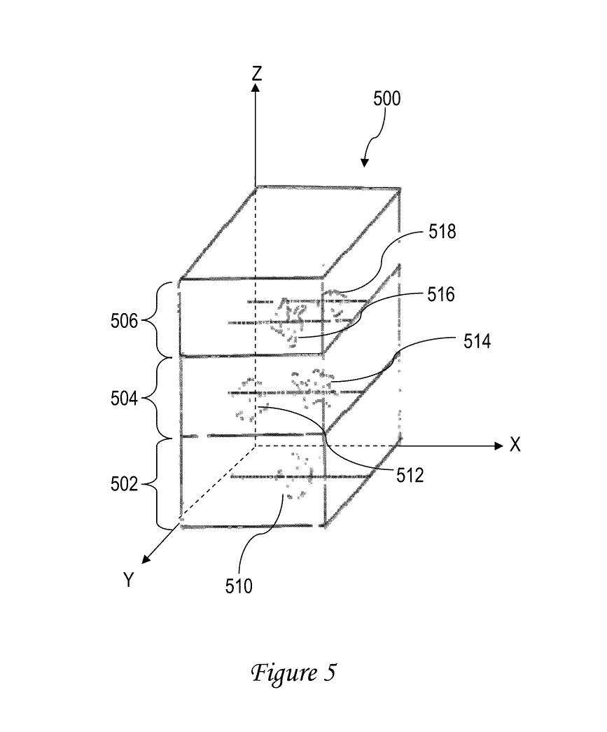

With reference now to FIG. 5, there is illustrated a vertical section 500 of an exemplary 3-D matrix as could be visualized by a microscope 200, 250 adjusted to capture multiple focal planes along the z-axis, including lower focal plane 502, middle focal plane 504, and upper focal plane 506 (where the total number of focal planes in a given well could be many more). In the illustrated example, vertical section 500 includes a cell 510 in the lower focal plane 502, cells 512 and 514 in the middle focal plane 504, and cells 516 and 518 on the upper focal plane 506. As described below, image processing tool 314 is configured to process video sequences captured by digital cameras 212,260 to automatically track the movement and morphology of cells as they move within and between focal planes 502, 504 and 506.

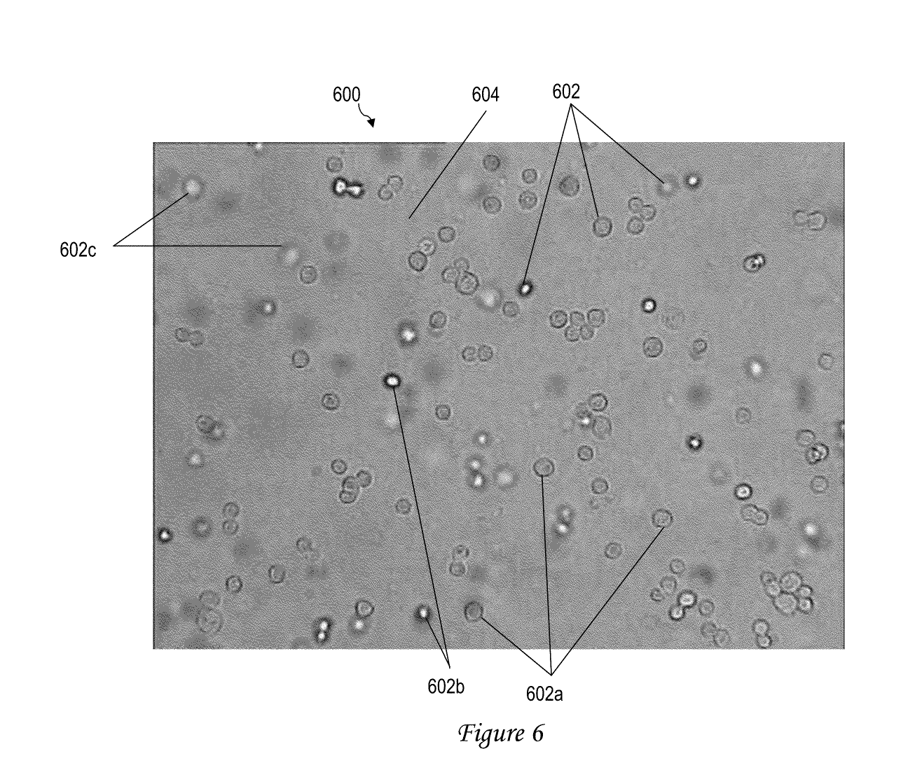

Referring now to FIG. 6, there is depicted an image 600 of living human pancreatic tumor cells 602 in a focal plane of a 3-D matrix 604 as captured by a digital camera 212 or 260 and stored within image database 310. Image 600 is an example of an image (frame) that can be processed in accordance with the techniques described herein to enable the automated visual recognition (detection), isolation and tracking of individual cells. As should be appreciated, the images processed in accordance with the techniques disclosed herein can also be of other tumor cells (e.g., melanoma cells or of breast, prostate, colon, lung, liver, ovarian, bladder or kidney carcinoma cells), or as noted above, leukocytes, stem cells or other living cells.

Cells locomote in a 3-D matrix, such as 3-D matrix 604, in all directions. At times, a cell will be partially in-focus and partially out-of-focus in a given image, and at some point in a video sequence a human observer would declare the cell to be completely invisible because it has completely left the focal plane of the video sequence and is visually indiscernible. In at least one embodiment, image processing tool 314 attempts to mimic the human observer in tracking cells in a single focal plane over time. Among other functions, image processing tool 314 can count the number of cells that enter and leave the plane of focus as a metric of cell motility. Additionally, image processing tool 314 can estimate the size and shape (morphology) of the in-focus portions of the cells, which tracked over time, provides additional measures of effects of particular substances (e.g., pharmacological substances) on the mechanics of cell locomotion. Additionally, image processing tool 314 can track the trans-location of individual cells as they move within (and between) the plane(s) of focus, including, for example, the distance traversed, the number of rest periods, the duration of resting, the duration of non-resting, and the distance traversed without resting, all which are all additional metrics that can be used, for example, to assess the potential effectiveness of a substance in preventing tumor cell migration.

In microscopy environments such as that illustrated in FIG. 2A, image processing tool 314 processes a sequence of images taken by a microscope 200 that has a fixed specimen stage 202 rather than a motorized X, Y and Z controlled stage. Consequently, the video sequence captured by the camera is from a single focal plane taken over time. In this embodiment, image processing tool 314 tracks cells as they move within the single focal plane and additionally tracks cells that enter and leave the single focal plane. Image processing tool 314 preferably further measures the 2-D cross section of each cell and monitors and records the changes in these cell cross sections over time.

In other embodiments such as that illustrated in FIG. 2B, image processing tool 314 controls a microscope 250 equipped with motorized specimen stage 252 that permits adjustment of focal plane location, for example, in 10 micrometer increments (with 1 micron resolution). The size of the movement increment and resolution is arbitrary and is optimized based on the size and speed of the cells, as well as other experimental parameters such as experiment run time. At various rates, image processing tool 314 commands motor pack 254 to move the stage along the z axis (which determines the focal plane) and then commands digital camera 260 to capture an image. The images taken at each focal plane are then grouped such that video sequences are formed at each focal plane. The distance between the focal planes is optimized based on the depth of the 3-D matrix. The number of focal planes sampled can vary and can be increased to increase the accuracy of the results or reduced to increase throughput. Further, by controlling the x and y movements of specimen stage 252, image processing tool 314 can captured video sequences from multiple wells of the same well plate.

In at least some embodiments, image processing tool 314 tracks cells as they transit from one focal plane to another. For each cell identified in an reference frame, image processing tool 314 moves the microscope's focal plane to the point of optimal focus for that cell. The process is repeated over time for each cell. Individual cells are tracked in three dimensions and over time, yielding 4-D tracking. The period of continuous observation and analysis may be milliseconds, seconds, minutes, hours or days.

In at least some embodiments, image processing tool 314 commands the motor pack 254 and digital camera 260 to perform a “scan” of each focal plane of the 3-D matrix and capture images of multiple adjacent regions of a focal plane, such that a larger composite image for each focal plane can be composed from the individual images captured in that focal plane.

In embodiments in which specimen stage 252 supports multiple wells, a human or robot can load the wells onto specimen stage 252, and image processing tool 314 commands motor pack 254 to move each well into position for scanning

As shown in FIG. 6, some cells within image 600 are clearly in focus, and some are only partially in focus. As a result, the cells take on different appearances, including: (1) in-focus cells, such as cells 602a, that are sharply defined and referred to herein as “black disks,” (2) partially in-focus cells, such as cells 602b, which appear to have a white center and thick black cell wall and are referred to herein as “ghosts,” and (3) out-of-focus cells, such as cells 602c.

In at least some embodiments, image processing tool 314 processes a reference frame (image) of a video sequence (whether or not the actual first frame in the video sequence) differently than subsequent frames of the video sequence. For example, image processing tool 314 may identify a reference set of cells in the reference frame and then search for cells belonging to the reference set of cells in subsequent frames. In processing the subsequent frames, image processing tool 314 may locate the cells appearing in the previous frame and thereafter search for newly appearing cells, if any.

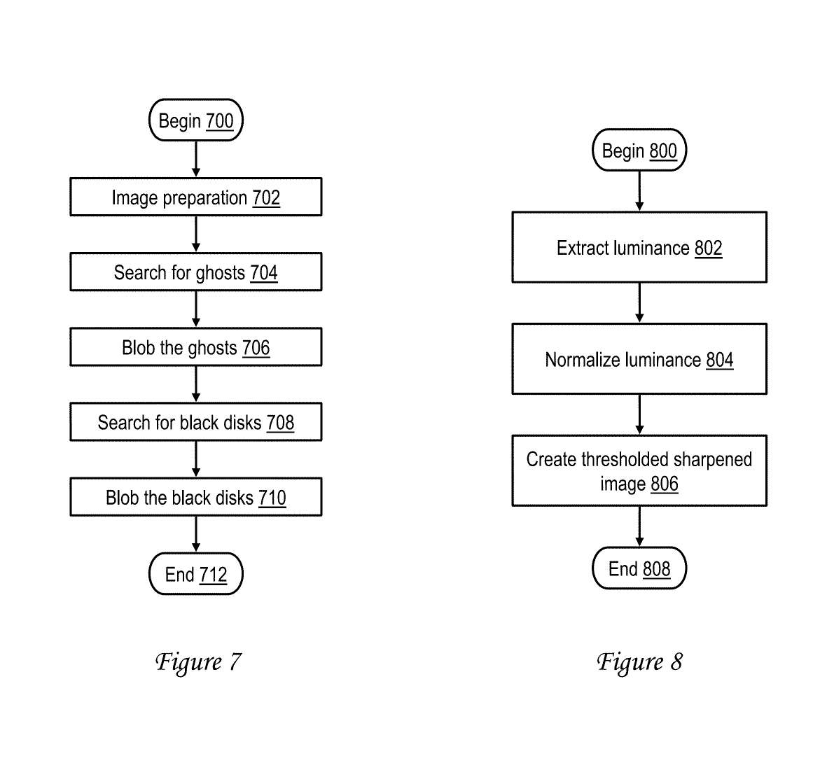

With reference now to FIG. 7, there is illustrated a high level logical flowchart of an exemplary process by which image processing tool 314 processes a reference frame of a video sequence. As with the other logical flowcharts presented herein, process steps are presented in a logical rather than strictly chronological arrangement, and in some embodiments at least some of the illustrated steps can be performed in a different order than illustrated or concurrently.

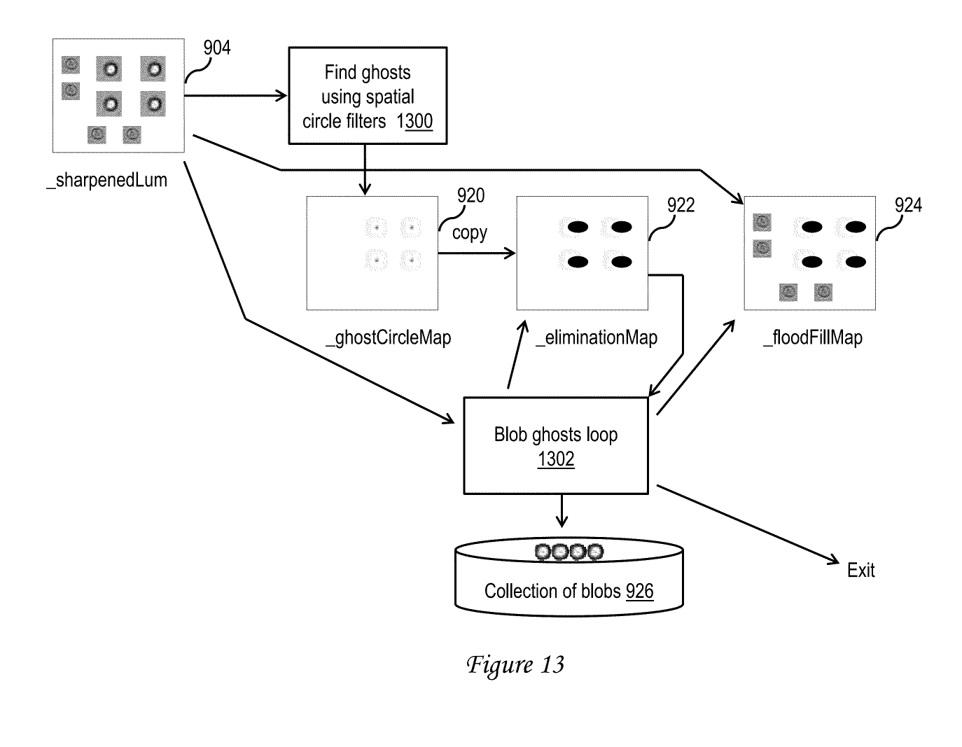

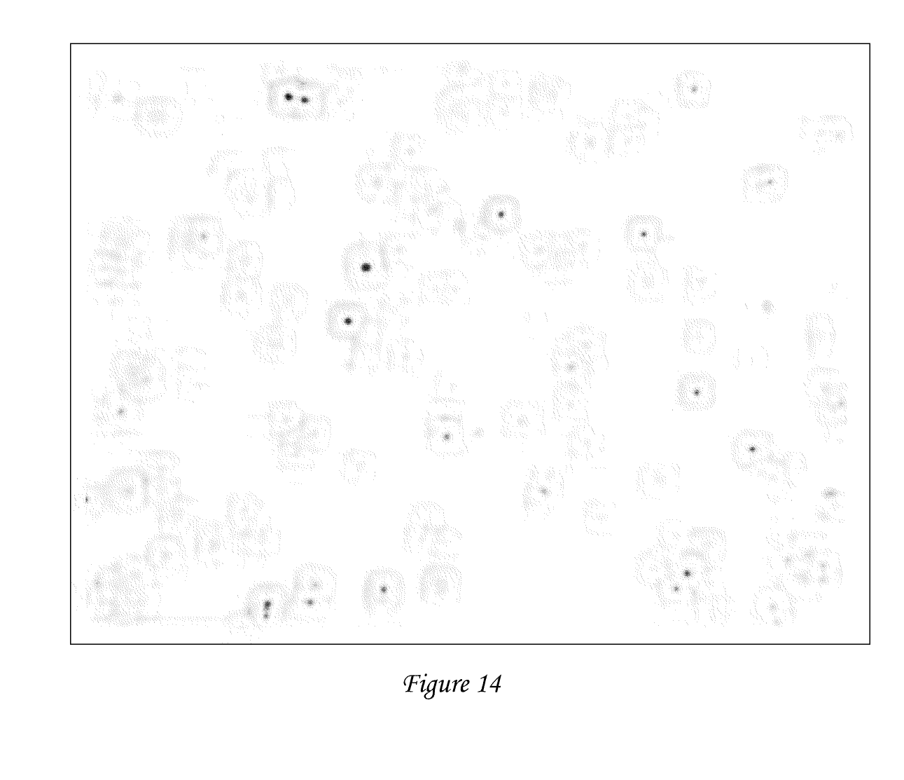

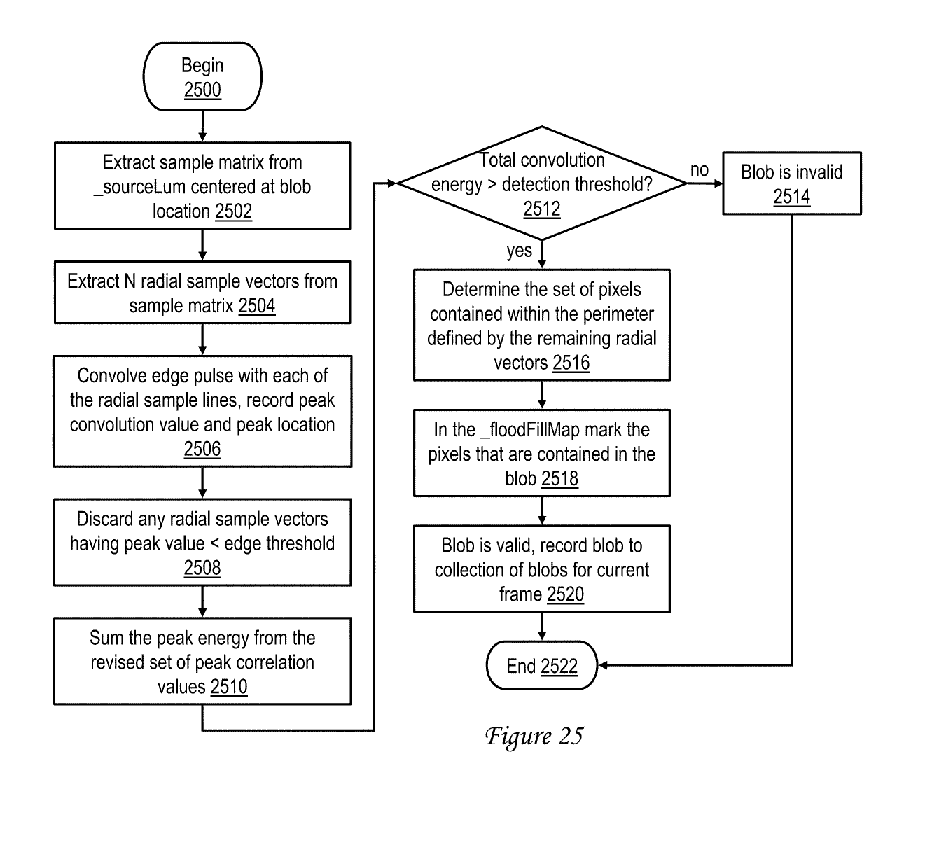

The process begins at block 700 and then proceeds to block 702, which depicts image processing tool 314 performing an image preparation process, such as the exemplary image preparation process described below with reference to FIG. 8. At block 704, image processing tool 314 searches for ghosts within the reference frame, as further described below with reference to the exemplary process shown in FIG. 13. At block 706, image processing tool 314 “blobs” the ghosts found at block 704. In the science of image processing, a “blob” is defined as a collection of pixels that represent an object in an image. Thus, “blobbing” is the process of isolating pixels that are to be considered part of the blob from other pixels (e.g., the background) in the image. An exemplary blobbing process that may be implemented at block 706 is described below with reference to FIG. 25. At block 708, image processing tool 314 locates black disks within the reference frame, as described below with reference to the exemplary process depicted in FIG. 14. At block 710, image processing tool 314 blobs the black disks found at block 708. The exemplary process depicted in FIG. 25 may also be utilized to blob the black disks at block 710.

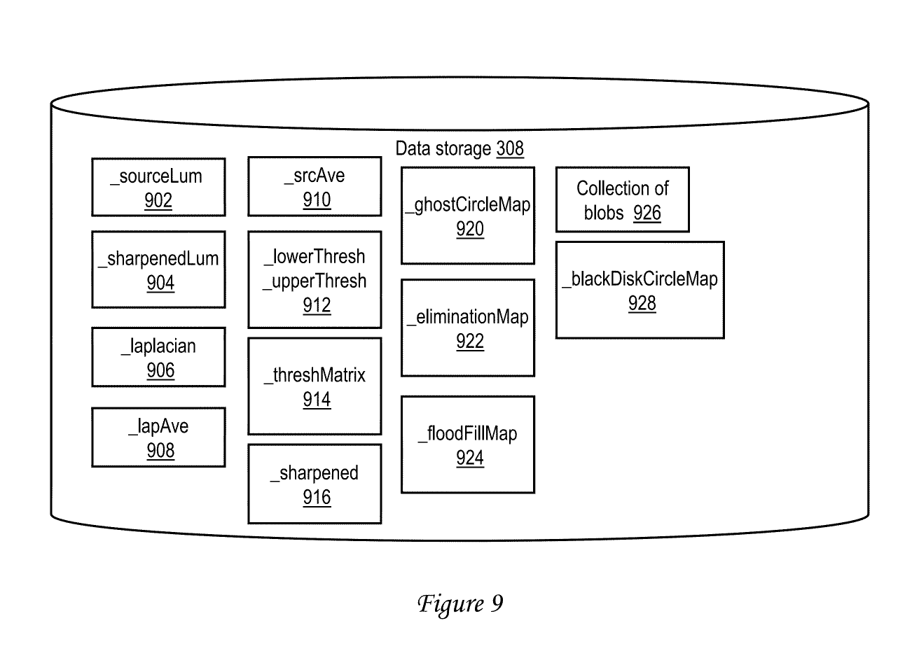

Referring now to FIG. 8, there is depicted a high level logical flowchart of an exemplary process for image preparation, which may be employed by image processing tool 314 at block 702 of FIG. 7. Data structures created or referenced in the image preparation process and in additional processing of a reference frame are depicted in FIG. 9 as stored within data storage 308.

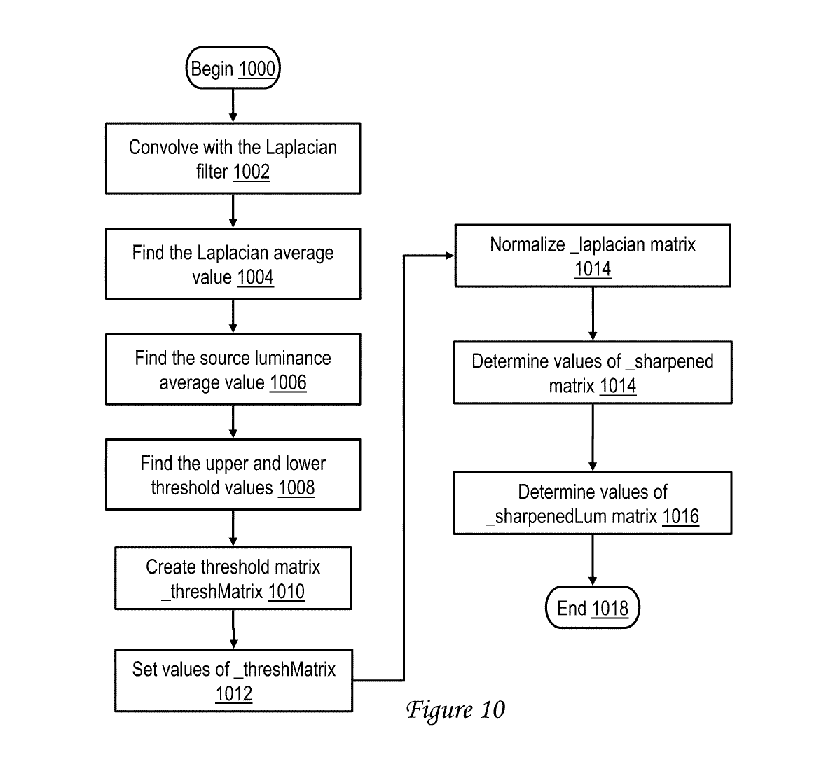

The process of FIG. 8 begins at block 800 and then proceeds to block 802, which illustrates image processing tool 314 extracting the luminance of an image from the Read-Green-Blue (RGB) color space, for example, using a conventional RGB-to-YUV color space conversion. At block 802, the extracted luminance (Y) values are normalized from the 0-255 range, for example, to a range of −500 to +500, and are stored as integers. The normalized luminance is stored in an image matrix, which is illustrated in FIG. 9 and referred to herein as_sourceLum matrix 902. At block 806, image processing tool 314 creates a thresholded sharpened image, for example, utilizing the exemplary process described below with reference to FIG. 10. The thresholded sharpened image can be stored, for example, in an image matrix, which is illustrated in FIG. 9 and referred to herein as _sharpenedLum matrix 904. Thereafter, the image preparation process of FIG. 8 ends at block 808.

With reference now to FIG. 10, there is illustrated a high level logical flowchart of an exemplary process for creating a thresholded sharpened image as previously depicted at block 806 of FIG. 8 will now be described. The process begins in FIG. 10 at block 1000 and then proceeds to block 1002, which depicts image processing tool 314 convolving _sourceLum matrix 902 generated in the image preparation process of FIG. 8 with a Laplacian filter. An example of a Laplacian filter that may be used in one embodiment is given below:

| | | | | |
|---|---|---|---|---|
| +1 | +1 | +1 | +1 | +1 |
| +1 | +1 | +1 | +1 | +1 |
| +1 | +1 | −16 | +1 | +1 |
| +1 | +1 | +1 | +1 | +1 |
| +1 | +1 | +1 | +1 | +1 |

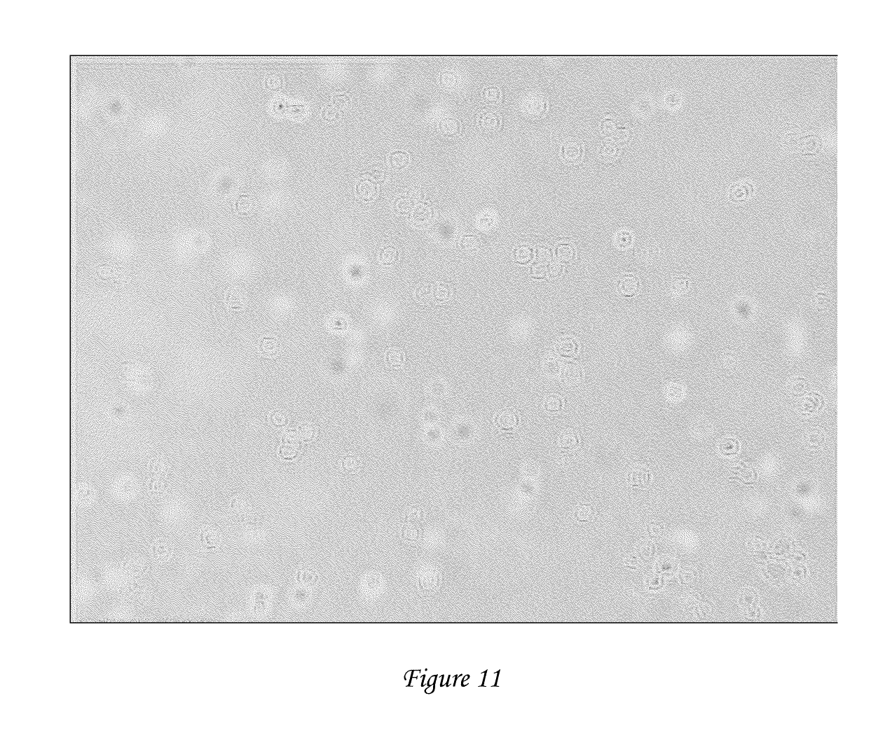

As shown in FIG. 9, the output of this convolution is stored (e.g., in data storage 308) in a matrix herein referenced as _laplacian matrix 906. FIG. 11 is a visualization of _laplacian matrix 906 assuming image 600 of FIG. 6 is the reference image. At block 1004, image processing tool 314 computes the arithmetic average of all pixels in _laplacian matrix 906 and stores the result, for example, as _lapAve 908 of FIG. 9. At block 1006, image processing tool 314 calculates the arithmetic average of all pixels in _sourceLum matrix 902 and stores the result, for example, as _srcAve 910 of FIG. 9. At block 1008, image processing tool 314 additionally finds the upper and lower threshold values 912 of FIG. 9. In one exemplary embodiment, upper and lower threshold values 912 can be found using the equations in the following pseudocode block:

```
if ( lapAve < 0 )
{
  _lowerThresh = lapAve + (lapThresholdPercent * lapAve )
  _upperThresh = lapAve − (lapThresholdPercent * lapAve )
}
else
{
  _lowerThresh = lapAve − (lapThresholdPercent * lapAve )
  _upperThresh = lapAve + (lapThresholdPercent * lapAve )
}
```

The process proceeds from block 1008 to block 1010, which illustrates image processing tool 314 initializing _threshMatrix 914, which is a matrix having the same dimensions as the reference image, as a empty set. At block 1012 image processing tool 314 sets the values of _threshMatrix 914, for example, in accordance with the following pseudocode:

```
For Each y in the set Y=0 to Y < Image-Height
{
  For Each x in the set X=0 to X < Image-Width
  {
    If ( _laplacian[x,y] < _lowerThresh
    OR _laplacian[x,y] > _upperThresh)
      Then _threshMatrix[x,y] =1;
      Else _threshMatrix[x,y] =0;
  }
}
```

At block 1014, image processing tool 314 normalizes the values of _laplacian matrix 906, for example, to the range −500 to 500. The process then proceeds from block 1014 to block 1016, which depicts determining the values of a _sharpened matrix 914, for example, in accordance with the following pseudocode:

```
For Each y in the set Y=0 to Y < Image-Height
{
  For Each x in the set X=0 to X < Image-Width
  {
    _sharpened[x,y] = _laplacian[x,y] + _sourceImage [x,y ]
  }
}
```

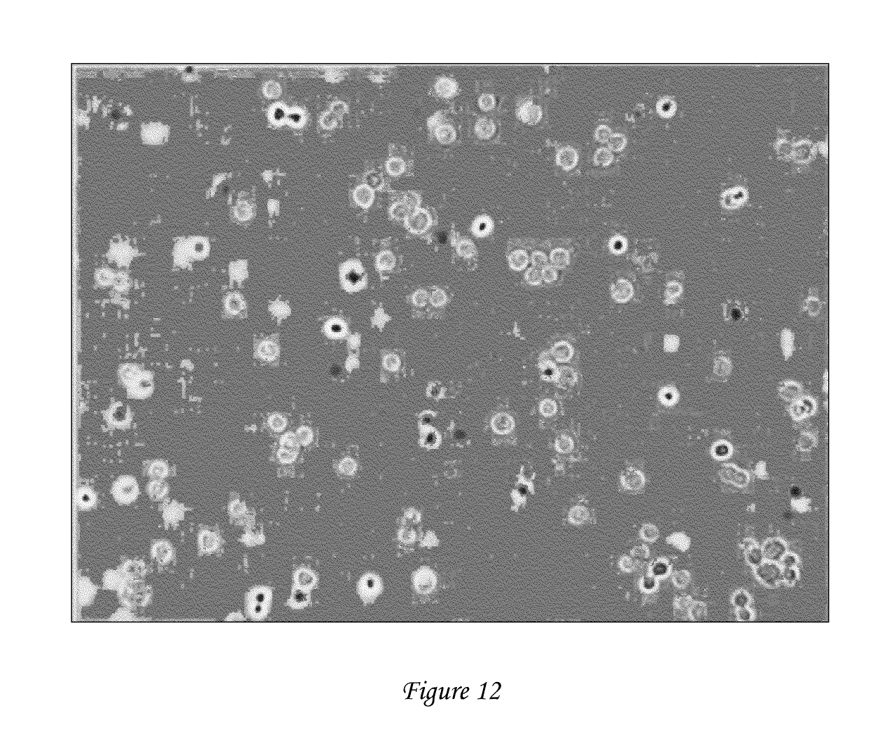

FIG. 12 is an exemplary visualization of a thresholded sharpened image obtained following block 1014, assuming that image 600 of FIG. 6 is the reference image.

At block 1016, image processing tool 314 determines the values of _sharpenedLum matrix 904, for example, in accordance with the following pseudocode:

```
For Each y in the set Y=0 to Y < Image-Height
{
  For Each x in the set X=0 to X < Image-Width
  {
  If (
  _threshMatrix[x−1,y−1] == 0 AND
  _threshMatrix[x,y−1] == 0 AND
  _threshMatrix[x+1,y−1] == 0 AND
  _threshMatrix[x−1,y] == 0 AND
  _threshMatrix[x−1,y] == 0 AND
  _threshMatrix[x−1,y] == 0 AND
  _threshMatrix[x−1,y+1] == 0 AND
  _threshMatrix[x−1,y+1] == 0 AND
  _threshMatrix[x−1,y+1] == 0
  )
    {
    Then _sharpenedLum[x,y] = imageAve
    Else _sharpenedLum[x,y] = _sharpened[x,y]
    }
  }
}
```

Image processing tool 314 preferably employs _sharpenedLum matrix 904 as the source image in finding ghosts and black disks in a frame, as depicted at blocks 704 and 708 of FIG. 7.

With reference now to FIG. 13, there is illustrated a process flow diagram of an exemplary process by which image processing tool 314 locates and extracts the ghosts within a reference frame as blobs (i.e., blobs the ghosts), as previously depicted at block 704 and 706 of FIG. 7. As shown, the process of FIG. 13 begins with an _sharpenedLum matrix 904, which in the exemplary case shown includes four ghosts and four black disks.

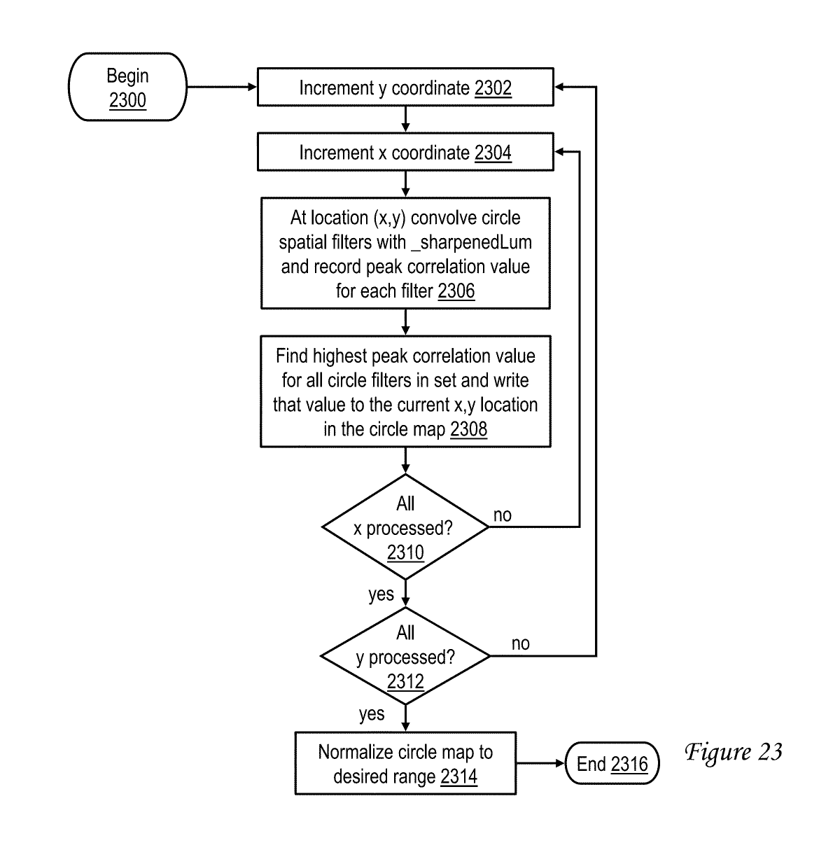

At block 1300, image processing tool 314 locates ghosts in the reference frame using circle spatial filters. An exemplary circle finding process that may be employed to locate ghosts in the reference frame is further described below with reference to FIG. 23, in which the circle finding process is given as input a set of circle spatial filters that represent ghosts. In the exemplary process, the set of circle spatial filters for finding ghosts comprise a single pattern replicated at multiple circle radii. A circle spatial filter is an image matrix in which the pixel values are set to −1, 1, or 0 in a pattern that forms a circle with a border. There are four features of the circle spatial filter: the internal fill value, the outer fill value (i.e., the fill values of the corners of a square matrix not covered by the circle), the outer border values, and the inner border values. The inner and outer border values describe a circular edge where the edge either transitions from −1 to 1 from the inside to outside or vice versa. Typically, radii of 6, 8, and 10 are useful for ghosts, depending on the size of the cells relative to the resolution of the images. In one embodiment, the circle spatial filters for ghosts are defined as:

fill value = +1
corner fill value = −1
outer border value = −1
inner border value = −1

Image processing tool 314 or a user can select other values for the circle spatial filters based on the appearance of the cells in the imagery and desired sharpness of focus on acquired cells. In addition, circle spatial filter types other than the circle spatial filters given above can be used. For example, a circle spatial filter consisting of a radial gradient calculator can alternatively be used.

The processing at block 1300 outputs a ghost circle map (_ghostCircleMap) 920, which is a reference image-sized matrix indicating the locations of ghosts in the reference image. Image processing tool 314 copies _ghostCircleMap 920 to initialize an _eliminationMap 922 that is used to eliminate from consideration ghosts that have been processed by a blobbing routine discussed below. FIG. 14 is a visualization of an exemplary _ghostCircleMap 920 in which the dark areas indicate strong circle spatial filter correlations and lighter areas represent lower correlation values, again assuming image 600 of FIG. 6 is the reference image.

At block 1302 of FIG. 13, image processing tool 314 performs a blob ghosts loop that finds the pixel in eliminationMap 922 with the highest value (i.e., strongest circle correlation) and passes this pixel location to the blob process described below with reference to FIG. 25. The blob ghosts loop depicted at block 1302 is described in the exemplary pseudocode presented below:

```
  minimumCircleMapValue = −25
  finished = false
  while ( NOT finished)
  {
    // bx and by are x,y coordinates of brightest pixel
    max = findBrightestSpot(IN _eliminationMap, OUT bx, OUT by );
    eliminateRegionAboutPoint ( IN x, IN y, IN-OUT _eliminationMap)
    if ( max < minimumCircleMapValue)
      {
      finished = true;
    }
    else
    {
      blobbingFunction(IN x, IN y, IN-OUT _floodFillMap )
    }
  }
function findBrightestSpot(input image, out bx, out by)
  {
    max = INT_MIN
    for each y in range y = 0 to y < imageHeight
    {
      for each x in range x = 0 to x < imageWidth
      {
        if ( (image[x,y] > max) )
        {
          max = image[x,y]
          bx = x
          by = y
        }
      }
    }
    return max;
  }
  // eliminateRegionAboutPoint marks a rectangular region as
  // visited so that it will not be found second time in FindBrightestSpot( )
  // the pixel value of −500 indicates a very small number that will
  // be below the minimumCircleMapValue threshold
  eliminateRegionAboutPoint ( IN sx, IN sy, IN-OUT eliminationMap)
  {
    r = 10 // chose radius = 10 as an approximation of typical cell radius
          // exact value of radius not critical
    startY = sy −r
    endY = sy + r
    startX = sx − r
    endX = sx+r
    for( y = startY; y < endY; y++ )
    {
      for( x = startX; x < endX; x++)
      {
        eliminationMap[x,y] = −500;
      }
    }
  }
```

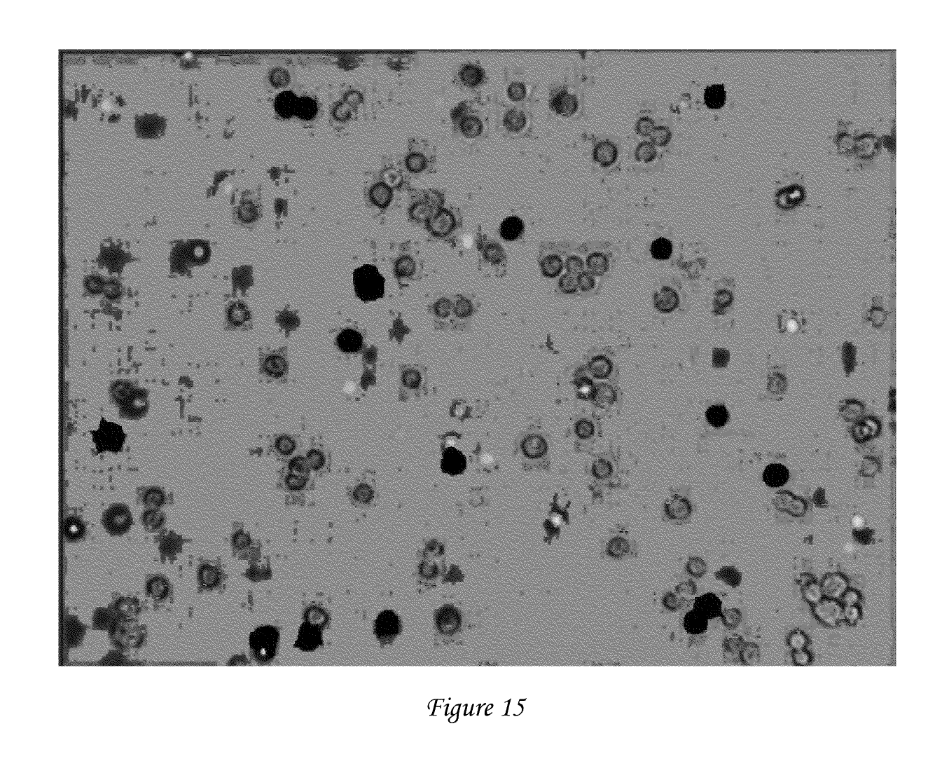

In the foregoing pseudocode, a minimumCircleMapValue of −25 has been found optimal based on the exemplary circle spatial filters presented herein and preferences for the number of cells isolated per frame and focus sharpness of the isolated cells. Further, in the foregoing pseudocode, the function call to “blobbingFunction( )” represents execution of a blobbing process, such as the exemplary blobbing process described below with reference to FIG. 25. Once a pixel location is selected for blobbing, the pixel location is marked in _eliminationMap 918 so that the pixel location will not again be processed as image processing tool 314 repeats blob ghosts loop 1308. The blobbing process will also mark valid blob pixels found in the blobbing process with a large negative number in the _floodFillMap 924 so that these same blobs will not be found a second time by the black disk finding process depicted at block 708 of FIG. 7. FIG. 15 is a visualization of _floodFillMap 924 after ghosts have been marked (e.g., colored black) by the blobbing process. The blobbing process, for example, as depicted in FIG. 25, also adds valid blobs to the collection of blobs 926 for the reference frame. The ghost finding and extracting process for the reference frame completes in response to exit from the blob ghosts loop 1302.

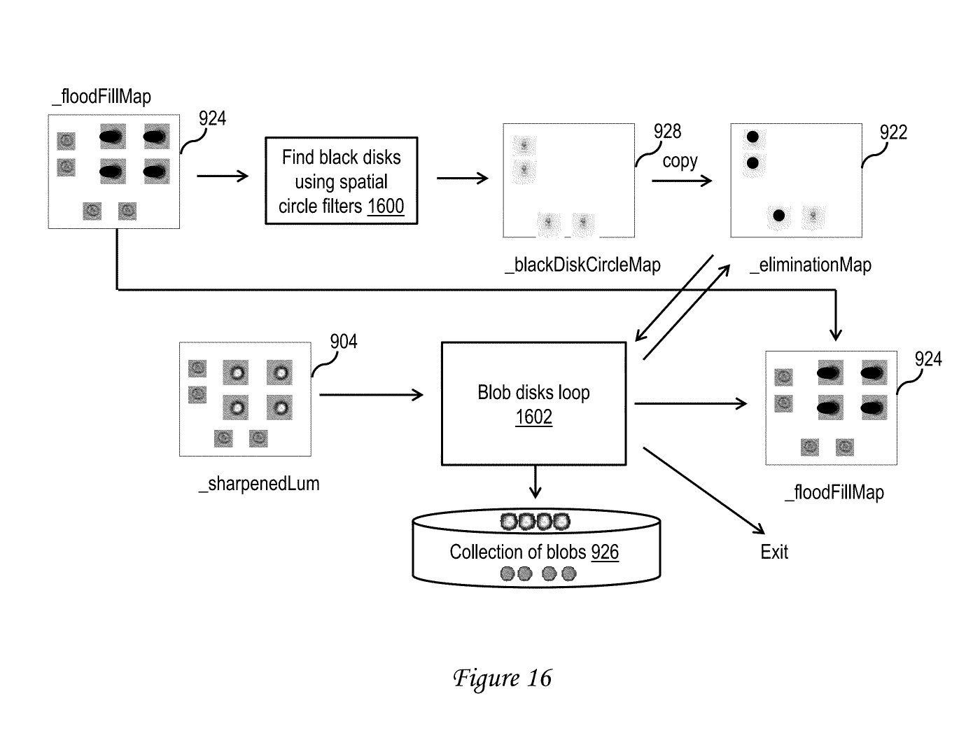

Referring now to FIG. 16, there is depicted an process flow diagram of an exemplary process by which image processing tool 314 locates and extracts black disks from a reference frame as depicted at block 708 of FIG. 7. As shown, _floodFillMap 924, which is an output of the ghost locating and extracting process depicted in FIG. 13, and _sharpenedLum matrix 904, which is an output of the image preparation process of FIG. 8, are inputs to the process of FIG. 16.

At block 1600, image processing tool 314 locates black disks using circle spatial filters. An exemplary circle finding process is further described in FIG. 23, which illustrates the circle finding process receiving as input a set of circle spatial filters which represent black disks. An exemplary set of circle spatial filters for finding black disks includes a single pattern replicated at multiple radii. Radii of 10, 12, and 14 have been found useful, depending on the size of the cells relative to the resolution of the images. In one embodiment, the circle spatial filters for black disks are defined with the following parameters:

fill value = 0
corner fill value = 0
outer border value = +1
inner border value = −1

Image processing tool 314 or a user may select other values for the circle spatial filters based on the appearance of the cells in the images. In addition, circle spatial filter types other than the circle spatial filters given above can be used. For example, a circle spatial filter consisting of a radial gradient calculator can alternatively be used.

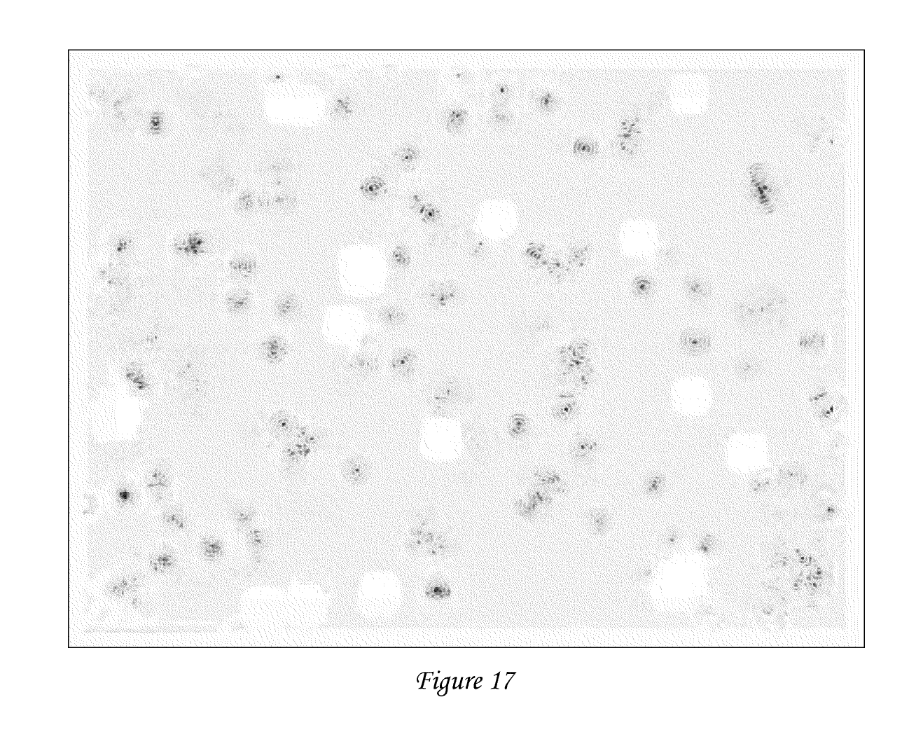

The black disk finding processing depicted at block 1600 outputs a _blackDiskCircleMap 928, which is a reference image-sized matrix identifying the locations of black disks in the reference image. Image processing tool 314 copies _blackDiskCircleMap 928 to obtain an updated _eliminationMap 922, which, as noted above, is utilized to eliminate black disks that have been processed in a blobbing routine from further consideration. FIG. 17 is a visualization of _blackDiskCircleMap 928 in which white patches represent the former locations of eliminated ghosts, dark areas indicate strong circle spatial filter correlations, and lighter gray areas represent lower correlation values.

At block 1602, image processing tool 314 performs a blob disks loop 1602 that finds the pixel in _eliminationMap 922 with the highest value (i.e., strongest circle correlation) and passes this pixel location to the blob process described below with reference to FIG. 25. The blob disks loop depicted at block 1602 can be implemented, for example, based on the exemplary pseudocode given above with reference to corresponding block 1302 of FIG. 13.

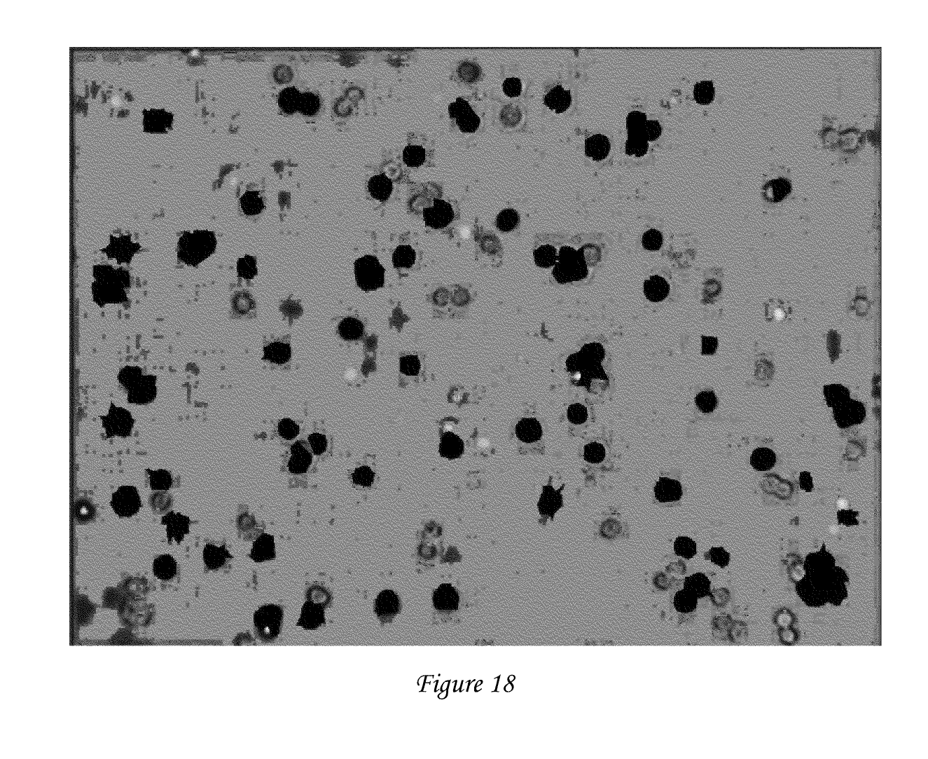

As with the processing of ghosts described above, the blobbing process of FIG. 25 also adds valid blobs for black disks to the collection of blobs 926 for the reference frame. As a convenience to the implementation and to enable re-use of code, the blobbing process can also optionally mark valid blob pixels that are found with a large negative number in _floodFillMap 924; however, such marking is not necessary as no processing of _floodFillMap 924 follows this step. The black disk finding and extracting process of FIG. 16 completes in response to exit from blob disks loop 1602. FIG. 18 is a visualization of _floodFillMap 924 after black disks and ghosts found in the reference frame have been marked by the blobbing process of FIG. 25.

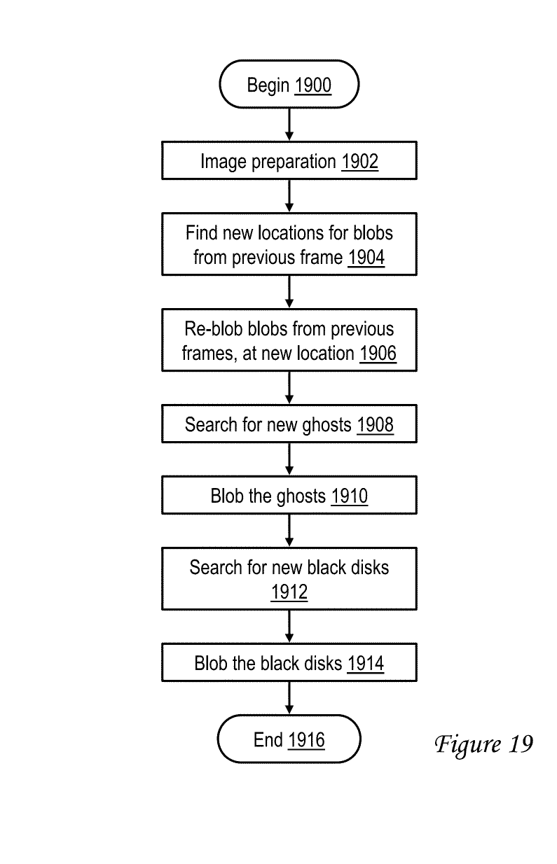

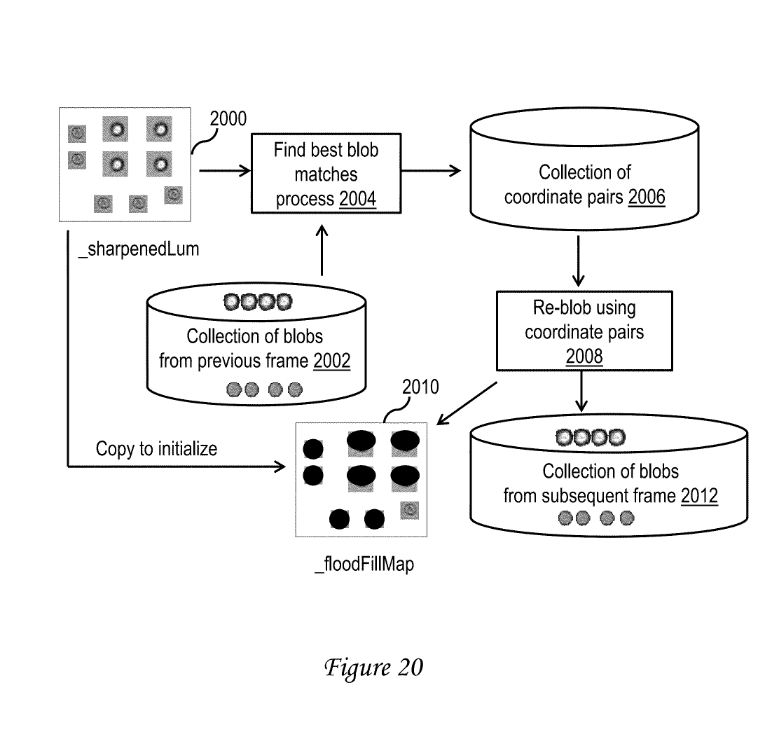

With reference now to FIG. 19, there is illustrated a high level logical flowchart of an exemplary process by which image processing tool 314 processes frames subsequent to the reference frame in a video sequence. The process begins at block 1900 and then proceeds to block 1902, which depicts image processing tool 314 performing an image preparation process, such as the exemplary image preparation process described above with reference to FIG. 8, on a subsequent frame. At blocks 1904-1906, image processing tool 314 finds new locations in the subsequent frame of blobs present in a previous frame of the video sequence and re-blobs such blobs at their new locations. An exemplary process by which image processing tool 314 performs the processing illustrated at blocks 1904-1906 is given in FIG. 20, which is described below.

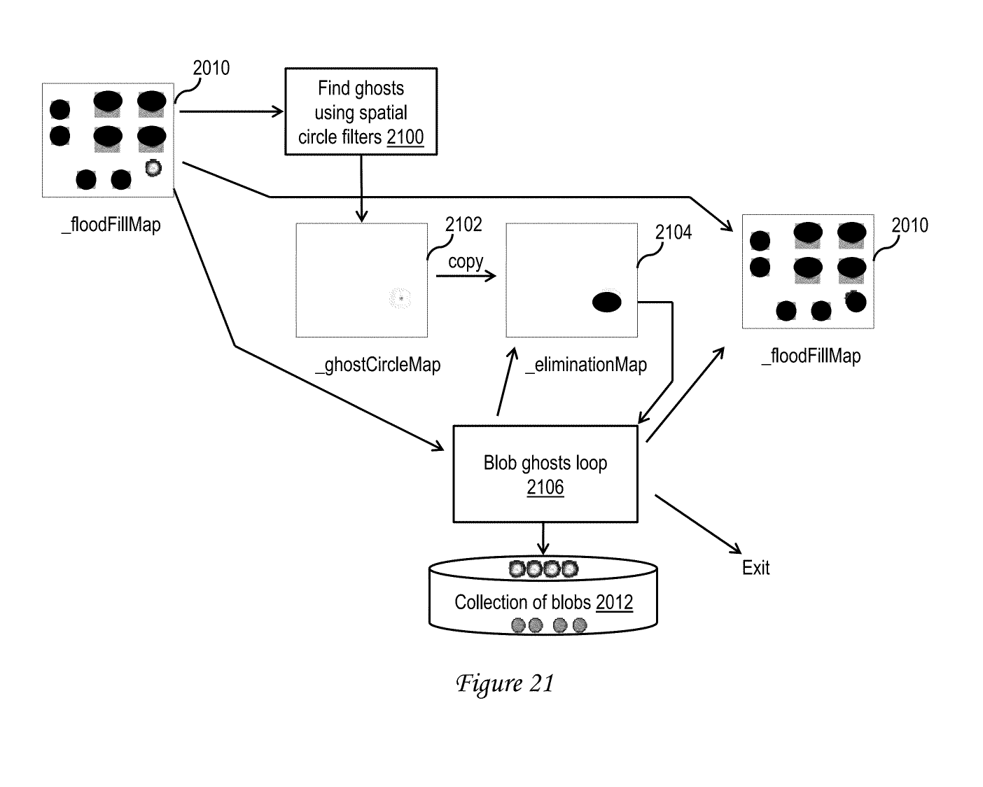

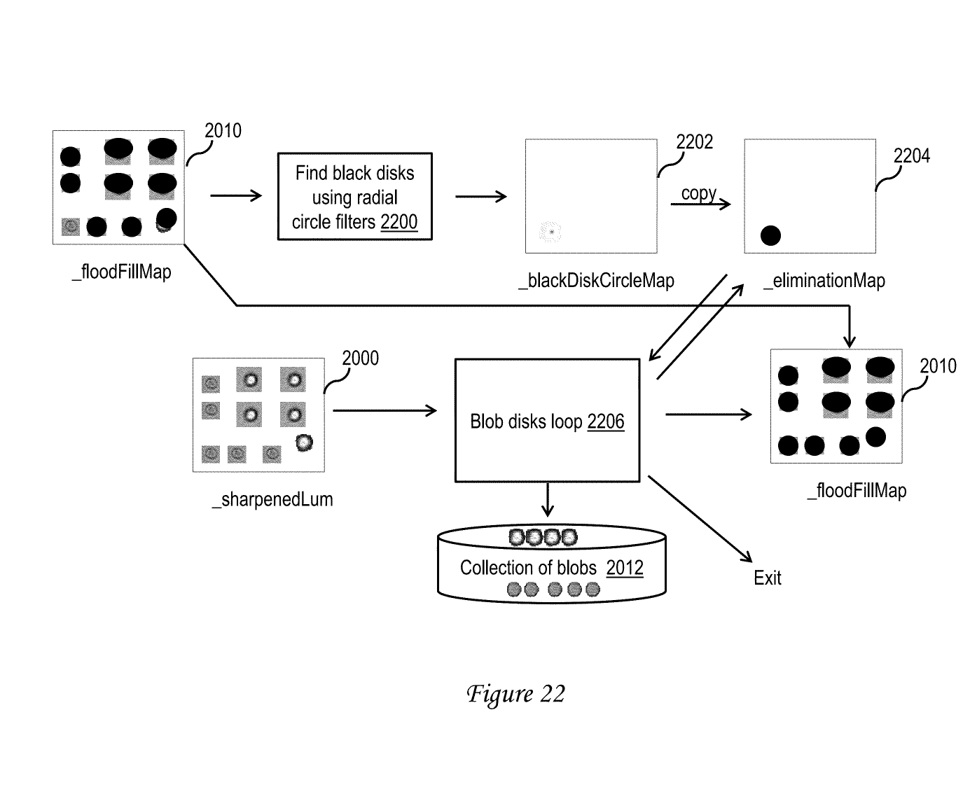

Following bock 1906, the process of FIG. 19 proceeds to blocks 1908-1910, which illustrate image processing tool 314 searching for ghosts newly appearing within the subsequent frame and blobbing the newly appearing ghosts, as further described below with reference to the exemplary process shown in FIG. 21. At blocks 1912-1914, image processing tool 314 locates newly appearing black disks within the subsequent frame and blobs the newly appearing black disks, as described below with reference to the exemplary process depicted in FIG. 22. The exemplary process of FIG. 25 can be utilized to blob the ghosts at block 1910 and blob the black disks at block 1914. Following block 1914, the process of FIG. 19 ends at block 1916.

Referring now to FIG. 20, there is illustrated a process flow diagram of an exemplary process by which image processing tool 314 locates in, and extracts from, a subsequent frame carry-over blobs that appeared in a previous frame of a video sequence, as previously illustrated at blocks 1904-1906 of FIG. 19. Because each video sequence is a time-ordered sequence of frames (images) at a particular focal plane of a 3-D matrix, the process of FIG. 20 tracks cells in a 2-D plane. In the exemplary tracking process, image processing tool 314 processes frames sequentially in time order, searching subsequent frames for blobs found in the reference frame. The pixels of the original blobs are compared to pixels in the subsequent frame in a search region centered at the previous location, and the best pixel match is determined to be the new location of the blob. The new location of the blob is then used as a center point reference to run the blobbing process again so that the new shape of the cell (not the original shape) is tracked.

In the process of FIG. 20, image processing tool 314 receives as an input a _sharpenedLum matrix 2000 for the subsequent frame as generated by the frame preparation process of FIG. 8. Image processing tool 314 also receives as an additional input the collection of blobs 2002 from the immediately previous frame in the video sequence.

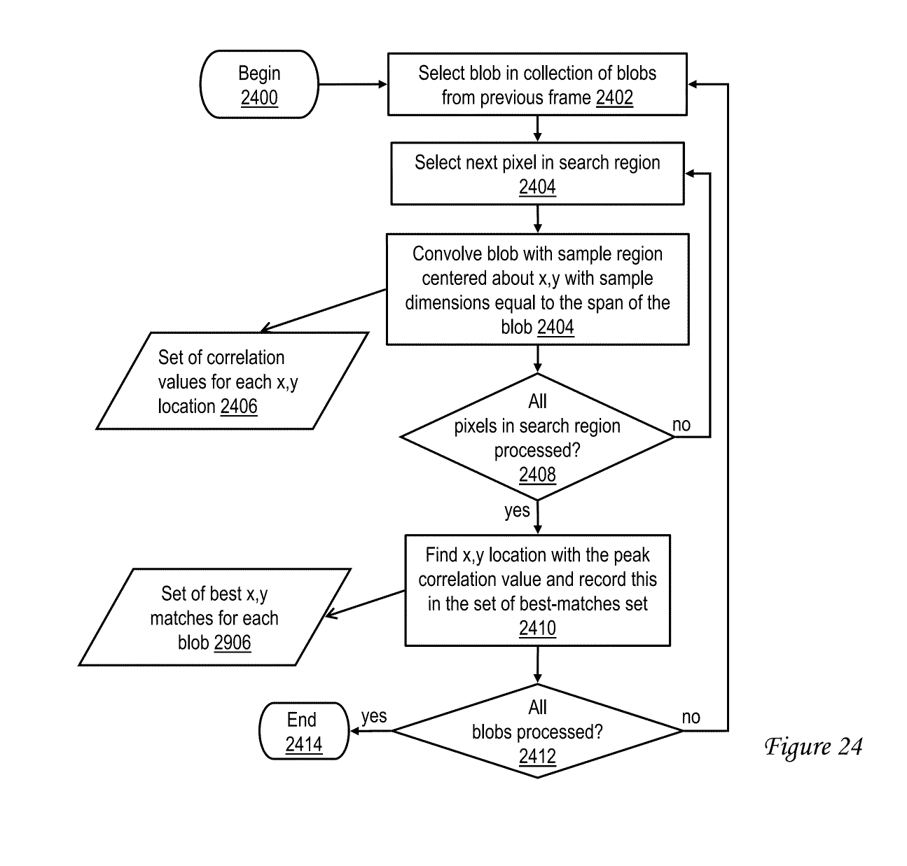

At block 2004, image processing tool 314 finds the best blob matches between the blobs in the subsequent frame and those in a previous frame, for example, in accordance with the process depicted in FIG. 24. The blob matching process of block 2004 generates a collection of coordinate pairs 2006 in which each coordinate (x,y) pair represents the best new location of a previously identified blob. At block 2008, image processing tool 314 performs the process of re-blobbing the blobs found in the subsequent frame, which runs the exemplary blobbing process of FIG. 25 on each of the coordinate pairs from the collection of coordinate pairs 2006. The blobbing process of FIG. 25 updates a _floodFillMap 2010 for the subsequent frame as previously described and also writes valid blobs to the collection of blobs 2012 for the subsequent frame, as in previous cases.

With reference now to FIG. 21, there is depicted a process flow diagram of an exemplary process by which image processing tool 314 locates and extracts newly appearing ghosts from a subsequent frame following the reference frame in a video sequence, as previously illustrated at blocks 1908-1910 of FIG. 19. The entry of cells into a given focal plane (e.g., from an edge of the frame or another focal plane) is a gradual process over the course of many frames. Initially, a cell will not be detected by the circle detector, or if detected, the blobbing process will fail to lock and reject the cell as a valid blob. If the cell continues to progress into the focal plane, the cell will eventually be validated by the blobbing process.

Prior to performing the process of FIG. 21, image processing tool 314 has already matched previously identified blobs in accordance with the process of FIG. 20, and the process of FIG. 21 receives as an input _floodFillMap 2010 output by that process. At block 2100, image processing tool 314 finds ghosts in the subsequent frame, for example, using the process of FIG. 23 and the ghost circle spatial filters used previously. The processing performed at block 2100 outputs a _ghostCircleMap 2102 indicating the location of a newly appearing ghost in the subsequent frame with a region of strong correlation. After the processing at block 2100 completes, image processing tool 314 copies _ghostCircleMap 2102 to initialize an _eliminationMap 2104 and then initiates processing of the frame in the blob ghosts loop as shown at block 2106 and as previously described with reference to bock 1302 of FIG. 13. The blobbing process of FIG. 25 called by the blob ghosts loop at block 2106 updates _floodFillMap 2010 and writes the newly found ghost blobs to the collection of blobs 2012 for the subsequent frame. When image processing tool 314 exits the blob ghosts loop depicted at block 2106, the process depicted in FIG. 21 completes.

With reference now to FIG. 22, there is illustrated a process flow diagram of an exemplary process by which image processing tool 314 locates and extracts newly appearing black disks from a frame subsequent to the reference frame of a video sequence, as previously illustrated at blocks 1912-1914 of FIG. 19. As indicated, the process of FIG. 22 receives the _floodFillMap 2010 output by the process of FIG. 21 as an input.

At block 2200, image processing tool 314 finds black disks newly appearing in the subsequent frame, for example, using the process of FIG. 23 and the black disk circle spatial filters used previously. The process for finding black disks illustrated at block 2200 outputs _blackDiskCircleMap 2202 indicating the locations of newly located black disks within the subsequent frame. After the processing at block 2200 completes, image processing tool 314 copies _blackDiskCircleMap 2202 to _eliminationMap 2204 and provides _eliminationMap 2204 to the blob disks loop depicted at block 2206. Additionally, the sharpenedLum matrix 2000 generated at block 1902 of FIG. 19 is also provided to block disks loop 2206 as an input.

The blob disks loop shown at block 2206 may be implemented using the process of FIG. 25, as noted previously with reference to block 1602 of FIG. 16. Blob disks loop 2206 writes blobs corresponding to black disks newly appearing in the subsequent frame to the collection of blobs 2012 for the subsequent frame. To allow re-use of code, blob disks loop 2206 may also optionally mark the blobs in _floodFillMap 2210; however, marking _floodFillMap 2210 is not necessary in this case because no additionally processing of _floodFillMap 2210 will follow this step. Following exit of blob disks loop 2206, the process of FIG. 22 completes.

With reference now to FIG. 23, there is illustrated a high level logical flowchart of an exemplary process by which image processing tool 314 finds cell locations by correlating image samples with circle spatial filters. In this embodiment, the set of circle spatial filters to be applied (e.g., a set of circle spatial filters for finding ghosts or a set of circle spatial filters for finding black disks) is created by an external process and passed to the process of FIG. 23 as an input.

The process of FIG. 23 begins at block 2300 and then enters a pair of nested loops in which each pixel, that is, each x,y coordinate pair in the frame (image), is processed. In the illustrated embodiment, the inner loop bounded by blocks 2304 and 2310 iterates through each x coordinate, and the outer loop bounded by blocks 2302 and 2312 iterates through each y coordinate; however, this order is arbitrary and other embodiments may traverse the image along the two axes in the opposite order. At block 2306, image processing tool 314 correlates a set of circle spatial filters with the current pixel selected by the nested loops and records the correlation sum for each circle spatial filter at that location (block 2306). When all circle spatial filters in the set of circle spatial filters have been correlated at the current pixel, the highest correlation value recorded for that pixel location is stored at the corresponding pixel (x,y) location in the relevant circle map 920, 928, 2102 or 2202 (block 2308). After all pixels in the subsequent frame are processed, the process of FIG. 23 proceeds to block 2314, which illustrates image processing tool 314 normalizing the values in the pixel map to a desired range, for example, from −500 to +500. Thereafter, the process of FIG. 23 ends at block 2316.

It should be understood that in alternative embodiments, spatial filters other than circle spatial filters may alternatively or additionally be employed. For example, the spatial filters may represent regular polygons, ellipses, non-circular ovals, or more complex shapes that can be assumed by cells. For example, in some embodiments, image processing tool 314 maintains a spatial filter library containing a plurality of different filter shapes that are designed to match the most common variations in cell shape. The spatial filter library can additionally include combinations of spatial filter shapes, for example, combinations of circle filters with line filters and/or rectangle filters that form a complex shapes representing a cell with an extended pseudopodia. The number of shape filters in the shape filter library and the complexity of the shape filters contained therein is limited only by throughput requirements and thus by the processing time and processing power available to match shape filters from the shape filter library against images of potential cells.

With reference now to FIG. 24, there is illustrated a high level logical flowchart of an exemplary process by which image processing tool 314 finds the best match in a subsequent frame of a blob from a preceding frame, as previously illustrated at block 2004 of FIG. 20. The exemplary process begins at block 2400 and then proceeds to block 2402, which illustrates image processing tool 314 selecting a blob for processing from the collection of blobs in the previous frame. Image processing tool 314 then processes each pixel in a search region centered about the former x,y location of the current blob under processing. In at least one embodiment, image processing tool 314 selects a radius (R) for the search region based, for example, on the maximum speed of the type of cell under study and the frame rate of the video sequence. Thus, at block 2404, image processing tool 314 selects pixels in the search region from the following ranges:

blob.x − R < x < blob.x + R
blob.y − R < y < blob.y + R

At block 2404, image processing tool 314 convolves the current blob taken from the previous frame with a sample region centered about the currently selected pixel in the search region, where the sample region has dimensions equal to the span of the current blob. The 2-D convolution result at each coordinate pair is recorded in a correlation result set 2406 for the current blob. As indicated by block 2408, the steps at blocks 2404-2408 are performed until all pixels in the search region are processed.

Following processing of all pixels in the search region, image processing tool 314 selects the coordinate pair associated with the strongest correlation value as the location of the best blob match in the subsequent frame for the blob from the previous frame (block 2410). As indicated by block 2412, once all blobs from the previous frame have been processed, the process of FIG. 24 ends at block 2414.

With reference now to FIG. 25, there is illustrated a high level logical flowchart of an exemplary process of blobbing that may be employed by image processing tool 314. As noted above, in the field of image processing, the terms “blob” and “blob detection” are often used to describe detection of a collection of pixels that are similar in color and brightness, but significantly different than the surrounding background. This meaning is generally employed herein, but is more specifically applied to a technique for isolating cells from their surrounding environment. That is, a “blob” is the collection of pixels that represent the image of a cell. The blobbing technique disclosed herein includes determination of an estimated perimeter of a cell, the location of the cell, and the collection of pixels enclosed by the cell.

The illustrated process begins at block 2500 and then proceeds to block 2502, which illustrates image processing tool 314 extracting a square sample matrix from the normalized _sourceLum matrix (e.g., _sourceLum matrix 902) centered about the blob location (e.g., an x,y coordinate pair) passed in as an input to the blobbing process. The size of the sample matrix should be selected to be large enough to enclose the largest possible cell under study.

At block 2504, image processing tool 314 creates N radial sample vectors formed of pixels on radial sample lines emanating from the x,y location as the circle center and radiating outward to the edge of the sample matrix. The N radial sample lines can be visualized as spokes of a wheel, where the image of the cell will be an irregular shape overlying the set of spokes. The N radial sample vectors are preferably evenly distributed, with the angle between each pair of adjacent radial sample vectors preferably being equal to 360/N degrees. In an exemplary embodiment, the value of N can range from 8 up to any arbitrary integer, but a value of N=16 has typically been found sufficient to define the perimeter of the cell.

At block 2506, image processing tool 314 convolves each of the N radial sample vectors with an edge pulse. Edge pulse definitions can be varied and can be selected by image processing tool 314 or a user based on the sharpness of the cell and the characteristics of the cell edges. One exemplary set of edge pulse definition can be given as follows:

```
if (isBlackDisk)
  {
    pulse[0] = 0;
    pulse[1] = 0;
    pulse[2] = +1;
    pulse[3] = +1;
    pulse[4] = +1;
    pulse[5] = 0;
    pulse[6] = 0;
    pulse[7] = −1;
    pulse[8] = −1;
    pulse[9] = −1;
    pulse[10] = 0;
    pulse[11] = 0;
  }
else if (isghost)
  {
    pulse[0] = 1;
    pulse[1] = 1;
    pulse[2] = 1;
    pulse[3] = 1;
    pulse[4] = 1;
    pulse[5] = 1;
    pulse[6] = 1;
    pulse[7] = 1;
    pulse[8] = −1;
    pulse[9] = −1;
    pulse[10] = −1;
    pulse[11] = −1;
  }
```

Image processing tool 314 records the value and location of the convolution peak energy along each of the N radial sample vectors. The location of the edge of the cell along a given radial sample vector is the location of the convolution peak energy less half the length of the edge pulse.

At block 2508, image processing tool 314 processes the convolution results to discard any of the N radial sample vectors not satisfying (e.g., having less peak energy than) a predetermined edge threshold defining how sharp the cell edges must be for detection. A threshold value of 35 is typical, but this value may vary. At block 2510, image processing tool 314 sums the total peak energy from each radial sample line remaining after the filtering performed at block 2508 and stores the sum as the total convolution energy.

At block 2512, image processing tool 314 determines whether the total convolution energy determined at block 2510 satisfies (e.g., is greater than) a detection threshold that determines how consistent the image of the cell perimeter must be to qualify for detection. A typical detection threshold value is 2000. If the total convolution energy does not satisfy the detection threshold, image processing tool 314 determines the blob to be invalid (block 2514) and accordingly ends the blob processing shown in FIG. 25 at block 2522. In a preferred embodiment, the invalid blob is discarded and is not be recorded in the collection of blobs 926, 2012 for the frame.

In response to a determination at block 2512 that the total convolution energy satisfies the detection threshold, meaning a valid blob is detected, processing continues at block 2516, which depicts image processing tool 314 determining the set of pixels contained within a polygon having a perimeter defined by the remaining radial sample vectors. Any standard mathematical technique for determining points within a polygon can be employed. These pixels will be deemed to be those comprising the blob.

For each pixel in the polygon corresponding to the blob, image processing tool 314 marks the corresponding location in the _floodFillMap 924 or 2010 (block 2518). At block 2520, image processing tool 314 additionally marks the blob as valid and adds to the blob to the collection of blobs 926, 2012 for the frame. Following block 2520, the blobbing process of FIG. 25 ends at block 2522.

As described herein, cells travel in the 3-D matrix in three dimensions. Microscopes with attached cameras capture images of cells that, for a possibly short period, transit a 2-D focal plane. In many cases, the focal plane is only a few microns thick, meaning that only a thin slice of a cell will be in focus as it crosses the focal plane. Cells that are above or below the focal plane are either not visible or are not clearly delineated. If a cell moves 20 microns (i.e., a usual cell diameter) up or down, the cell will be invisible. All prior art techniques for measuring continual cell locomotion measure cell motility in two dimensions. The present disclosure improves upon these prior 2-D metrics with additional 3-D motility metrics, which can be measured, visualized (e.g., displayed or printed) and/or reported by IARV 316. Further, IARV 316 can, in response to default or user-specified upper and/or lower notification thresholds, provide special notification of particular specimen(s) or even particular cells for which one or more of the metrics satisfies the default and/or user-specified upper and/or lower thresholds.

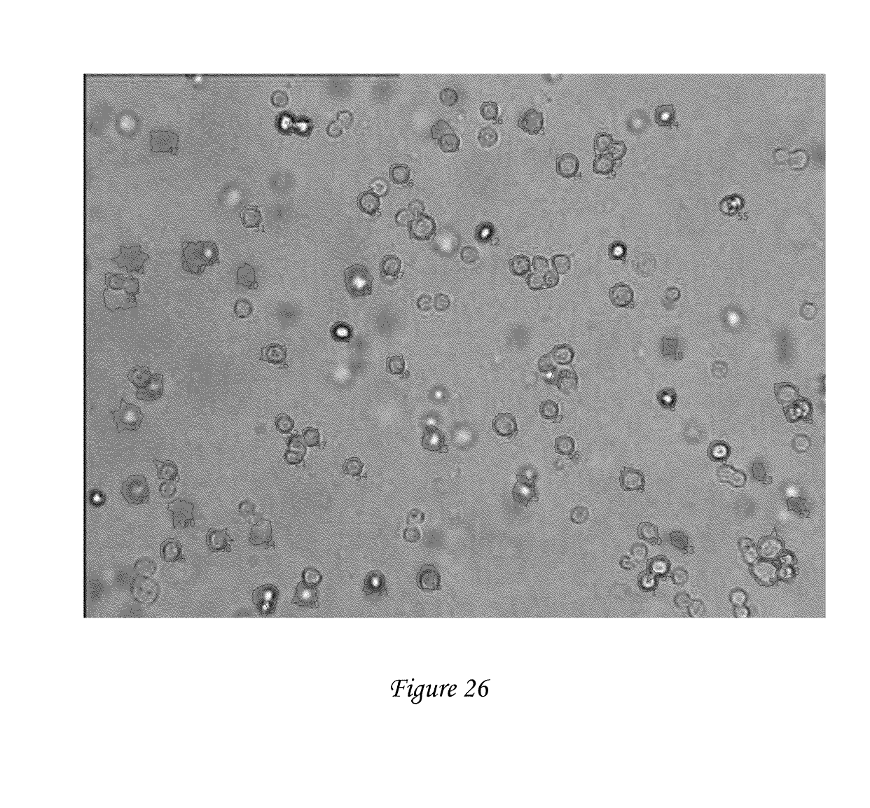

Referring now to FIG. 26, there is depicted a visualization of cells in a 2-D focal plane of a 3-D matrix that can be output by IARV tool 316. In FIG. 26, IARV 316 presents lines encompassing each cell identified within the image, thus identifying the estimated perimeter of the cell. Image processing tool 314 automatically assigns an identifier (e.g. a string of alpha and/or numeric characters) to each cell, and these identifiers may be presented by IARV 316 overlaying or in conjunction with the image. The depicted image represents only one of many possible visualizations of the cell data and in other embodiments, color, blinking or any other graphic or visual technique can be utilized to designate cells identified for tracking within an image or to distinguish cells satisfying various criteria for motility, morphology and/or frequency. Image processing tool 314, as described below, formulates an estimate of each cell's perimeter and location, and tracks these changes over time (from frame-to-frame in the video sequence). IARV 316 can automatically visualize and/or report the cell data in any method that is convenient to the users of data processing system 300. Consequently, it is no longer necessary to manually draw lines around cells or assign identifiers to cells. Further, visualization is not required for cell tracking metrics to be acquired.

Exemplary 3-D motility metrics include those listed below.

Number of cells that translated (NCT)—To be counted as a translated cell, the cell's center point must have translated more than a translation threshold from the cell's location in the reference frame. The translation threshold can vary, but the default translation threshold can be, for example, twenty pixels, which is the typical diameter of a cell. NCT can be reported both as a total and as a percentage of tracked cells. Both NCT metrics can be reported over time.

Distance translated (DT) for individual cells—The total distance traveled between a cell's location in the reference frame and its location in a final frame of a video sequence.

Greatest distance translated (GDT)—The maximum DT for any cell captured in the video sequence.

Total number of covered pixels (TNCP) for individual cells—Aggregate number of unique pixels covered by the center of an individual cell.

Total distance covered (TDC) by all cells—Aggregate number of pixels (not unique pixels) covered by the cell center of any cell during the video sequence.

Coherence—Computed as TDC/DT, which provides a metric regarding how much the cells move in straight lines versus tortuous paths. Straighter cell paths yield a smaller coherence number.

IARV 316 can additionally extract, present and report cell morphology metrics based on data contained in the blob data structures, which contain information regarding an estimated geometric center of a blob, pixel locations on the perimeter of the blob, and sample vectors of a slice of the cell within a given 2-D focal plane. As noted above, the number of radial sample vectors utilized to describe a blob is not critical to the validity of the measurements, but the same number of radial sample vectors R should be used (or compensated for) in comparative studies. Numbers of radial sample vectors higher or lower than 32 can be useful depending on various constraints, including computational speed/costs and the desired accuracy. Exemplary cell morphology metrics include those listed below.

Maximum span (MXS)—For each cell, in each frame, the maximum distance between two radial perimeter points on radial sample vectors located in opposing quadrants of a circle centered on the geometric center of the cell. For a given cell, this maximum distance over the course of all frames in a video sequence is the MXS.

Minimum span (MNS)—For each cell, in each frame, the minimum distance between two radial perimeter points on radial sample vectors located in opposing quadrants of a circle centered on the geometric center of the cell. For a given cell, this minimum distance over the course of all frames in a video sequence is the MNS.

Spherical factor (SF)—A measure of a cell's roundness equal to one minus the standard deviation of the radial sample vector magnitudes divided by the average radial vector length. In other words, if SD is the standard deviation of the radial sample vectors magnitudes and AVE is the mean value of the radial vector lengths, then SF=1−(SD/AVE).

Separation event count (SEC)—The total number of cell separation events for all cells in the video sequence, whether by mitosis events or simple separation of two or more cells that are touching. In one embodiment, to determine if two or more cells are touching or have separated, IARV 316:
1. sets the perimeter-touching-threshold to be 10% of the average MXS for all cells in the frame.
2. if a cell center is within an MXS distance of another cell, compares the perimeter pixel locations for minimal distance between the two cells (e.g., using the blob data).
3. if any two perimeter points (one point from each of the two cells being compared) are closer than the perimeter-touching-threshold, counts the two cells as touching.
4. if in any one frame two cells are considered to be touching and in the subsequent frame they are no longer touching, then a separation event has occurred. If one of the two cells is not found in the subsequent frame, a separation event is also counted as having occurred.

IARV 316 can additionally extract, present and report cell various frequency metrics. These frequency metrics include those listed below. Some of these metrics were first identified and measured using manual techniques for a small number of cells. The use of automated methods as described herein increases the number of cells tracked from 30 or so cells per specimen to thousands and dramatically increases the resolution and accuracy of the measurements.

Observation interval—For frequency studies, cell locomotion is tracked in terms of rest intervals and locomotion intervals, and the location of each cell is compared from frame to frame. To determine the optimum observation interval, IARV 316:
1. finds the cell which had the maximum translocation over the video sequence.
2. for this maximum locomoting cell, finds the smallest time interval for which motion is measured, where motion is defined, for example, as a translocation of the cell center by more than ½ of the maximum span of the cell in that frame.
3. sets the observation interval to be at least twice this smallest time interval.

Frequency of Locomotion (FOL)—The number of intervals the cell locomoted more than a threshold distance divided by the total time the cell was visible.

Number of rest intervals (NORI)—The number of time intervals where the cell was motionless.

Number of activity intervals (NOAI)—The number of time intervals where the cell locomoted.

Frequency of breaks (FOB)—The number of times the cell was motionless (e.g., locomoted less than a threshold distance) divided by the total time the cell was visible.

Velocity—The peak velocity observed in any of the observation intervals as defined by the peak distance from the start of the observation interval divided by the duration of observation interval.

Speed—The average of all non-zero cells velocities (i.e., cell rest intervals, which have zero velocities, are excluded).

Maximum locomotion interval—The maximum time a cell remains in a state of locomotion.

Maximum rest interval—The maximum time a cell remains in a state of rest.

Using the observation interval, IARV 316 can determine and express all of the morphological metrics as rates of change over time, as indicated by the following examples.

Perimeter modulation rate (PMR)—For each cell, the average rate of change in length of all radial sample vectors.

Maximum span (MXS) average rate of change—For each cell, the average of the change in MXS over each observation interval.

Minimum span (MNS) average rate of change—For each cell, the average of the change in MNS over each observation interval.

Spherical factor (SF) average rate of change—For each cell, the average of the change in SF over each observation interval will be calculated.

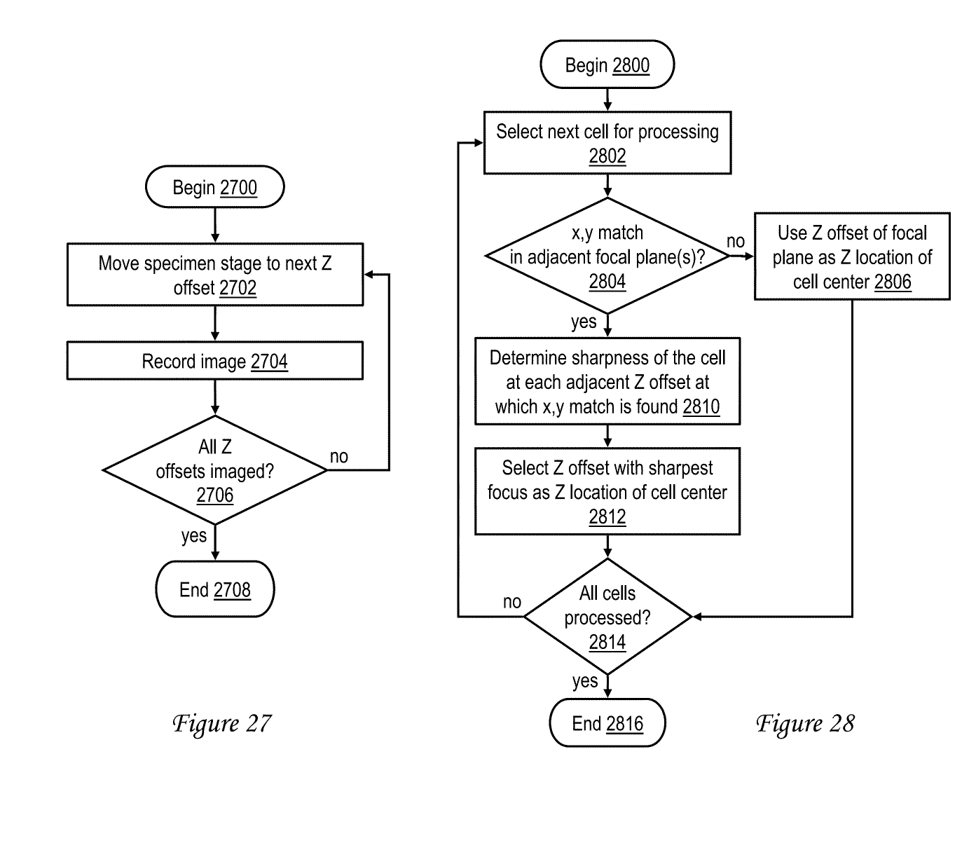

By moving the focal plane up and down, for example, by applying appropriate control of a motor-controlled specimen stage 252 (or alternatively by moving objective lens 258 and/or digital camera 260), image processing tool 314 can capture images of a specimen at multiple focal planes having micron or submicron Z offsets from one another, thus forming a vertical stack of images at different focal planes along the Z axis. For example, FIG. 27 illustrates a high level logical flowchart of an exemplary method by which image processing tool 314 captures images of a given specimen at multiple Z offsets at a given time sample. The process of FIG. 27 begins at block 2700 and then proceeds to block 2702, which illustrates image processing tool 314 causing data processing system 300 to provide control signals to motor pack 254 to cause motor pack 254 to position specimen stage 252 at a next (or first) desired Z offset, thus establishing a focal plane for digital camera 260 within a particular specimen well. At block 2704, image processing tool 314 records the image captured by digital camera 260 at the present Z offset within image database 310. At block 2706, image processing tool 2706 determines whether or not images have been captured at all desired Z offsets for the present time sample. If not, the process returns to block 2702, which has been described. If, however, image processing tool 314 determines that an image has been captured at each desired Z offset for the current time sample, the process of FIG. 27 ends at block 2708.

Image processing tool 314 can track individual cells through along the Z axis of the 3-D matrix by using the above described 2-D cell locating algorithms for each focal plane and then matching x,y coordinate locations. For each cell, the focal plane in which the cell has maximum focus becomes the 3-D reference location (x,y,z) for that cell at that sample time.

Referring now to FIG. 28, there is depicted a high level logical flowchart of an exemplary method by which image processing tool 314 determines the Z position for each cell located in one or more images of a given specimen taken at a given sample time (e.g., where such cells have been located in corresponding frame data structures 326 of different collection containers 324 that all correspond to a particular sample time). The process of FIG. 28 begins at block 2800 and then proceeds to block 2802, which illustrates image processing tool 314 selecting for processing the next cell that was located at the selected sample time using the previously described 2-D cell locating techniques. At block 2804, image processing tool 314 determines whether or not the cell was located in multiple adjacent focal planes by attempting to find matching x,y coordinates for the cell in one or more frames captured at the sample time in one or more adjacent focal planes. In response to a positive determination at block 2804, the process proceeds to block 2810, which is described below. However, in response to a negative determination at block 2804, which means the cell was located in only one focal plane at the selected sample time, image processing tool 314 records the Z offset of the single focal plane in which the cell was located as the Z location of the cell's center at the sample time. The process then proceeds to block 2814, which illustrates image processing tool 314 determining whether or not additional cells remain to be processed. If not, the process ends at block 2816. If, however, image processing tool 314 determines at block 2814 that one or more additional cells remain to be processed, the process of FIG. 28 returns to block 2802, which has been described.

Referring now to block 2810, image processing tool 314 determines the sharpness of the focus of the cell at each adjacent Z offset at which an x,y coordinate match for the selected cell was found. For example, in one embodiment, image processing tool 314 determines the sharpness of focus at block 2810 by convolving a common edge detection filter across the cell image on 2 or more axes and recording the maximum peak edge energy from the convolutions. At block 2812, image processing tool 314 selects the Z offset of the focal plane in which the cell is in the sharpest focus as the location of the cell's center. In an embodiment that employs convolution with an edge detection filter to determine sharpness of focus, block 2812 entails image processing tool 314 selecting the Z offset of the focal plane in which the convolution generated the greatest maximum peak edge energy as the Z location of the cell's center. The process proceeds from block 2812 to block 2814, which has been described.

Based on the Z location of a cell determined, for example, by the process of FIG. 28, image processing tool 314 can track the cell in 3-D (x,y,z) space, and IARV 316 can determine and report equivalent metrics to the 2-D metrics listed above in the three spatial dimensions as well as over time. IARV 316 can also provide additional metrics, such the number of focal plane crossings (e.g., the number of times a cell comes into focus).

As an alternative to moving the focal plane by motor control of a microscope element as described with reference to FIG. 27, adjustment of the focal plane along the Z axis can alternatively be performed in software (e.g., image processing tool 314) following image capture. For example, in U.S. Patent Application 2011/0234841, Lytro, Inc. disclosed a multi-focal-plane digital camera that captures light field vector information and stores it in a file container to allow the focus and perspective of the image to be modified by post-processing of the light field vector information. In at least some embodiments, a multi-focal plane camera, such as that disclosed by Lytro, Inc., may be employed in place of the conventional digital cameras 212 and 260 previously described. In embodiments employing a multi-focal plane camera, images at a plurality of focal planes can be generated by image processing tool 314 after image capture, for example, using the API provided by Lytro, Inc. or similar software. Such images can then be processed as previously described.

Alternatively or additionally, image processing tool 314 can direct the multi-focal-plane software to focus on each cell individually. In this embodiment, feedback from the API indicating the depth of the field of focus of a particular cell provides the Z-axis location of that cell.

As will be appreciated, employing a multi-focal-plane camera eliminates the need for mechanized movement of an element of the microscope and can dramatically speed the process of capturing 3-D images, allowing for higher throughput of a robotic system which moves multiple specimens through a single microscope unit. Employing a multi-focal plane camera also ensures that each cell is optimally in-focus.

The disclosed systems, methods and program products can be leveraged in many different applications. For example, one application is the in vitro testing of the capacity of pharmacological substances (and different concentrations or combinations of such substances) to inhibit and/or reduce cell motility (e.g., tumor cell migration), target morphologies or event frequencies, and the disclosed automation of such testing potentially enables the screening of hundreds of pharmacological substances per day. Similarly, another application is the in vitro testing of the capacity of pharmacological substances (and different concentrations or combinations of such substances) to stimulate or increase cell motility, target morphologies or event frequencies. Either or both of these metrics can be automatically compared to the inherent motility, morphology and event frequencies of the cells.

Further, another application is recognizing, tracking and/or analyzing the movement and shape (morphology) of cellular structures, such as the cell membrane, pseudopodia, etc., even when the cell as a whole does not translocate. As described above, the perimeter of a cell and changes in cell shape can be automatically recognized, tracked, and analyzed. This recognition can take place in time intervals of microseconds, milliseconds, minutes, hours and days. IARV tool 316 can present and/or report various metrics related to cell structure and morphology, for example, absolute values of in pseudopodia length, pseudopodia width, and total cell circumference (distance around the cell), changes in pseudopodia length, pseudopodia width, and total cell circumference, and rates of changes of these metrics.

Another application is the automatic recognition, tracking and analysis of the chemotactic migration of cells (e.g., tumor cells) within a 3-D matrix in a chemotaxis chamber.

Another application is the automatic tracking of cells that have not been exposed to a substance (“control”) and comparison of associated data and analyses with those from other experiments that use known substances that stimulate cell migration (“positive control”) or inhibit (“negative control”) cell migration. In a further aspect these data and analyses can be compared to substances, the stimulatory or inhibitory properties of which are to be determined (“test substances”). These test substances can be tested within various concentration ranges, including picomolar, nanomolar, micromolar, millimolar and molar concentrations.

Another application is the screening of freshly isolated tumor cells obtained from an individual cancer patient against known or potential inhibitory substances (which may be chemical or biological) prior to the beginning of therapy to prognostically determine the probability of success of the potential inhibitory substance on the individual patient's particular tumor. The probability of success of one or more therapies can be predicted (e.g., by IAVR 316), for example, based on the relative change in motility, target morphologies, and/or event frequencies of tumor cells exposed to the potential inhibitory substance as compared to a control. Further, the success of a treatment can be predicted (e.g., by IAVR 316) by mapping determined cell motility, target morphologies, and/or event frequencies (or changes thereto in response to an inhibitory substance) to a knowledge base 307 of therapy outcomes (see, e.g., FIG. 3). As one example, outcome knowledge base 307 may include information correlating tumor cell motility measurements with observed patient outcomes for one or more time periods following therapy (e.g., three years and/or five years). The correlation between motility measurements and outcomes can be utilized to predict metastatic potential of tumor cells both with and without one or more therapies. In a more complex example, outcome knowledge base 307 can record patient outcomes for specific tumor types correlated to one or more factors, including, but not limited to genomic analysis, histological analysis, and migration, frequency and morphology metrics. Based on the probability of success of one or more therapies and/or the detected metrics for tumor cell motility, frequency and/or morphology and/or changes in the metrics for tumor cell motility, frequency and/or morphology in the presence of an inhibitory substance, IAVR 316 can further automatically select for recommendation a treatment plan from a treatment plan knowledge base 309 (see, e.g., FIG. 3) based on the screening.

Another application is screening of the migratory, anti-migratory and anti-metastatic potential by the potential stimulation or inhibition by a chemical or biological substance against a migration panel of established, commercially available tumor cell lines that have proven intrinsic migratory activity. This migration panel can include one or more of the following tumor cell lines:

PC-3 (prostate carcinoma)

MCF-7 (breast carcinoma, ER positive, luminal-like)

MDA-MB-468 (breast carcinoma, basal-like)

MDA-MB-231 (breast carcinoma, basal-like)

HT29 (colon carcinoma)

SW480 (colon carcinoma)

SW620 (colon carcinoma, metastasis of SW480)

MV3 (melanoma)

NB4 (myeloid leukaemia)

Dohh-2 (B cell leukaemia)

Molt-4 (T cell leukaemia)

IMIM-PC2 (pancreatic carcinoma)

PANC1 (pancreatic carcinoma)

CFPAC1 (pancreatic carcinoma)

ES-2 (ovarian cancer)

T-24 (bladder cancer)

HepG2 (hepatocellular carcinoma)

A-549 (non-small cell lung cancer, adenocarcinoma)

HTB-58 (non-small cell lung cancer, squamous carcinoma)

SCC4 (tongue squamous carcinoma)

Of course, the disclosed techniques may also be utilized to recognize, track and analyze previously unknown and uncharacterized tumor cells and tumor cell lines to determine their intrinsic migratory activity, as well as their potential stimulation or inhibition by a chemical or biological substance.

Another application is screening for migratory and anti-migratory activity by the potential stimulation or inhibition of a chemical or biological substance against a known panel of tumor cell lines, the NCI 60 panel, developed by the National Cancer Institute. This panel of tumor cell lines, which represents the current scientific standard for the investigation of cell growth, proliferation, cytotoxicity, and apoptosis, includes the following:

| Leukemia | CNS | Renal |
|---|---|---|
| CCRF-CEM | SF-268 | 786-0 |
| HL-60 | SF-295 | A498 |
| K-562 | SF-539 | ACHN |
| MOLT-4 | SNB-19 | CAKI-1 |
| RPMI-8226 | SNB-75 | RXF 393 |
| SR | U251 | SN12C |
| | | TK-10 |
| | | UO-31 |
| Non-Small Cell Lung | Melanoma | Prostate |
| A549 | LOX IMVI | PC-3 |
| EKVX | MALME-3M | DU-145 |
| HOP-62 | M14/MDA-MB-435 | |
| HOP-92 | SK-MEL-2 | |
| NCI-H226 | SK-MEL-28 | |
| NCI-H23 | SK-MEL-5 | |
| NCI-H322M | UACC-257 | |
| NCI-H460 | UACC-62 | |
| NCI-H522 | | |
| Colon | Ovarian | Breast |
| COLO 205 | IGR-OV1 | MCF7 |
| HCC-2998 | OVCAR-3 | MDA-MB-231 |
| HCT-116 | OVCAR-4 | MDA-MB-468 |
| HCT-15 | OVCAR-5 | HS 578T |
| HT29 | OVCAR-8 | MDA-N |
| KM12 | NCI/ADR-RES | BT-549 |
| SW-620 | SK-OV-3 | T-47D |

As has been described, in some embodiments a data processing system receives an image of a matrix including a plurality of living cells. The data processing system automatically locates a cell among the plurality of living cells in the image by performing image processing on the image. In response to locating the cell, the data processing system records, in data storage, a position of the cell in the image. The data processing system may further automatically determine, based on the image, one or more selected metrics for the cell, such as one or more motility metrics, one or more frequency metrics and/or one or more morphology metrics. Based on the one or more metrics, the data processing system may further automatically determine a probability of success of a therapy on a patient employing a test substance and/or automatically select a treatment plan for recommendation.

While the present invention has been particularly shown as described with reference to one or more preferred embodiments, it will be understood by those skilled in the art that various changes in form and detail may be made therein without departing from the spirit and scope of the invention. For example, although aspects have been described with respect to a data processing system executing program code that directs the functions of the present invention, it should be understood that present invention may alternatively be implemented as a program product including a storage device (e.g., DRAM, SRAM, EEPROM, ROM, flash memory, CD-ROM, DVD, magnetic disk, etc.) storing program code that can be processed by a data processing system to perform the disclosed functions.

What is claimed is:

1. A method of data processing, comprising:
a data processing system receiving an image of a matrix including a plurality of living cells;
the data processing system automatically locating a cell among the plurality of living cells in the image by performing image processing on the image; and
in response to locating the cell, the data processing system recording, in data storage, a position of the cell in the image.

2. The method of claim 1, wherein receiving the image comprises receiving the image in a video sequence of a plurality of images having a common focal plane within the matrix.

3. The method of claim 2, and further comprising:
building a data structure that time-orders the plurality of images.

4. The method of claim 3, wherein the building includes building a plurality of data structures including the data structure, wherein each of the plurality of data structures corresponds to a respective one of a corresponding plurality of focal planes within the matrix.

5. The method of claim 2, and further comprising:
building a data structure that contains per-cell data for each of the plurality of images captured at the common focal plane.

6. The method of claim 2, wherein:
the image is a reference image of the video sequence and the position is a first position;
the video sequence includes a subsequent image captured subsequent to the reference image; and
the method further includes the data processing system automatically locating the cell at a subsequent position in the subsequent image and recording, in the data storage, the second position in association with the cell.

7. The method of claim 6, wherein automatically locating the cell at the subsequent position includes convolving a blob representing the cell with a sample region of the subsequent image.

8. The method of claim 6, and further comprising:
locating others of the plurality of cells in the subsequent image after locating the cell in the subsequent image.

9. The method of claim 1, wherein the locating includes preparing a thresholded sharpened image from the received image and searching for the cell in the thresholded sharpened image.

10. The method of claim 1, wherein the locating includes:
locating multiple of the plurality of cells in the image by separately searching for cells that are nearly in-focus and cells that are in-focus.

11. The method of claim 1, wherein the locating includes:
identifying a prospective cell location by convolving a sample region with a spatial filter; and
validating the prospective cell location by determining that a convolution energy computed by convolving an edge pulse with multiple radial sample vectors centered on the prospective cell location satisfies a threshold.

12. The method of claim 1, wherein:
the matrix is a three-dimensional matrix; and
the method further comprises controlling an element of a microscope to enable capture of a plurality of images including the image, wherein multiple of the plurality of images are captured at different focal planes.

13. The method of claim 12, wherein multiple of the plurality of images are captured at a same focal plane.

14. The method of claim 1, wherein:
the matrix is a three-dimensional matrix;
the image is a first image captured at a first focal plane within the matrix;
the position is a first position; and
the method further comprises the data processing system automatically locating the cell at a second position in a second image captured at a different second focal plane within the matrix and recording, in the data storage, the second position in association with the cell.

15. The method of claim 1, and further comprising automatically determining and recording a motility metric for the cell based on the position.

16. The method of claim 1, and further comprising automatically determining and recording a frequency metric for the cell based on the position.

17. The method of claim 1, and further comprising automatically determining a morphology metric for the cell from the image.

18. The method of claim 17, wherein automatically determining a morphology metric for the cell includes automatically determining a morphology metric for a subcellular structure of the cell.

19. The method of claim 1, and further comprising automatically determining, based on the image, a selected metric for the cell among a set including a motility metric, a frequency metric and a morphology metric.

20. The method of claim 19, and further comprising determining and recording a difference in a value of the selected metric from a control value due to presence of a test substance in the matrix.

21. The method of claim 1, wherein the cell is taken from a set including cancer cells, leukocytes, stem cells, fibroblasts, natural killer (NK) cells, macrophages, T lymphocytes (CD4⁺ and CD8⁺), B lymphocytes, adult stem cells, dendritic cells, professional Antigen presenting cells (pAPC), neutrophil, basophil and eosinophil granulocytes.

22. The method of claim 21, wherein the cell is a cancer cell taken from a set including commercially available tumor cell lines, modified tumor cell lines, and tumor cells of a patient.

23. The method of claim 22, wherein the cancer cell is from a commercially available tumor cell line taken from a set including PC-3 (prostate carcinoma), MCF-7 (breast carcinoma, ER positive, luminal-like), MDA-MB-468 (breast carcinoma, basal-like), MDA-MB-231 (breast carcinoma, basal-like), HT29 (colon carcinoma), SW480 (colon carcinoma), SW620 (colon carcinoma, metastasis of SW480), MV3 (melanoma), NB4 (myeloid leukaemia), Dohh-2 (B cell leukaemia), Molt-4 (T cell leukaemia), IMIM-PC2 (pancreatic carcinoma), PANC 1 (pancreatic carcinoma), CFPAC1 (pancreatic carcinoma), ES-2 (ovarian cancer), T-24 (bladder cancer), HepG2 (hepatocellular carcinoma), A-549 (non-small cell lung cancer, adenocarcinoma), HTB-58 (non-small cell lung cancer, squamous carcinoma), and SCC4 (tongue squamous carcinoma).

24. The method of claim 23, wherein the cancer cell is from a tumor cell line in a NCI 60 panel.

25. The method of claim 22, wherein:
the cell is taken from tumor cells of a patient;
the matrix includes a test substance; and
the method further comprises:
automatically determining, based on the image, a selected metric for the cell among a set including a motility metric, a frequency metric and a morphology metric;
automatically determining, based on the selected metric, probability of success of therapy on the patient employing the test substance and reporting the probability of success.

26. The method of claim 25, wherein:
the cell is taken from tumor cells of a patient;
the matrix includes a test substance; and
the method further comprises:
automatically determining, based on the image, a selected metric for the cell among a set including a motility metric, a frequency metric and a morphology metric;
and
automatically selecting a treatment plan for recommendation based on the selected metric and reporting the recommended treatment plan.

27. A method of data processing, comprising:
a data processing system automatically determining, based on image processing of a plurality of images captured from a matrix including living cells of a patient and a test substance, one or more metrics for the living cells among a set including a motility metric, a frequency metric and a morphology metric; and
the data processing system automatically determining, based on the one or more metrics, a probability of success of a therapy on the patient employing the test substance and reporting the probability of success.

28. A method of data processing, comprising:
a data processing system automatically determining, based on image processing of a plurality of images captured from a matrix including living cells of a patient and a test substance, one or more metrics for the living cells among a set including a motility metric, a frequency metric and a morphology metric; and
the data processing system automatically selecting a treatment plan for recommendation based on the one or more metrics and reporting the recommended treatment plan.

29. A data processing system, comprising:
a processor; and
data storage coupled to the processor, wherein the data storage includes program code that, when executed by the processor, causes the data processing system to perform:
receiving an image of a matrix including a plurality of living cells;
automatically locating a cell among the plurality of living cells in the image by performing image processing on the image; and
in response to locating the cell, recording a position of the cell in the image.

30. The data processing system of claim 29, wherein receiving the image comprises receiving the image in a video sequence of a plurality of images having a common focal plane within the matrix.

31. The data processing system of claim 30, wherein the program code, when executed, further causes the data processing system to perform:
building a data structure that time-orders the plurality of images.

32. The data processing system of claim 31, wherein the building includes building a plurality of data structures including the data structure, wherein each of the plurality of data structures corresponds to a respective one of a corresponding plurality of focal planes within the matrix.

33. The data processing system of claim 30, wherein the program code, when executed, further causes the data processing system to perform:
building a data structure that contains per-cell data for each of the plurality of images captured at the common focal plane.

34. The data processing system of claim 30, wherein:
the image is a reference image of the video sequence and the position is a first position;
the video sequence includes a subsequent image captured subsequent to the reference image; and
wherein the program code, when executed, further causes the data processing system to perform automatically locating the cell at a subsequent position in the subsequent image and recording, in the data storage, the second position in association with the cell.

35. The data processing system of claim 34, wherein automatically locating the cell at the subsequent position includes convolving a blob representing the cell with a sample region of the subsequent image.

36. The data processing system of claim 34, wherein the program code, when executed, further causes the data processing system to perform:
locating others of the plurality of cells in the subsequent image after locating the cell in the subsequent image.

37. The data processing system of claim 29, wherein the locating includes preparing a thresholded sharpened image from the received image and searching for the cell in the thresholded sharpened image.

38. The data processing system of claim 29, wherein the locating includes:
locating multiple of the plurality of cells in the image by separately searching for cells that are nearly in-focus and cells that are in-focus.

39. The data processing system of claim 29, wherein the locating includes:
identifying a prospective cell location by convolving a sample region with a spatial filter; and
validating the prospective cell location by determining that a convolution energy computed by convolving an edge pulse with multiple radial sample vectors centered on the prospective cell location satisfies a threshold.

40. The data processing system of claim 29, wherein:
the matrix is a three-dimensional matrix; and
wherein the program code, when executed, further causes the data processing system to perform controlling an element of a microscope to enable capture of a plurality of images including the image, wherein multiple of the plurality of images are captured at different focal planes.

41. The data processing system of claim 40, wherein multiple of the plurality of images are captured at a same focal plane.

42. The data processing system of claim 29, wherein:
the matrix is a three-dimensional matrix;
the image is a first image captured at a first focal plane within the matrix;
the position is a first position; and
wherein the program code, when executed, further causes the data processing system to perform automatically locating the cell at a second position in a second image captured at a different second focal plane within the matrix and recording, in the data storage, the second position in association with the cell.

43. The data processing system of claim 29, wherein the program code, when executed, further causes the data processing system to perform:
automatically determining and recording a motility metric for the cell based on the position.

44. The data processing system of claim 29, wherein the program code, when executed, further causes the data processing system to perform:
automatically determining and recording a frequency metric for the cell based on the position.

45. The data processing system of claim 29, wherein the program code, when executed, further causes the data processing system to perform:
automatically determining a morphology metric for the cell from the image.

46. The data processing system of claim 45, wherein automatically determining a morphology metric for the cell includes automatically determining a morphology metric for a subcellular structure of the cell.

47. The data processing system of claim 29, wherein the program code, when executed, further causes the data processing system to perform:
automatically determining, based on the image, a selected metric for the cell among a set including a motility metric, a frequency metric and a morphology metric.

48. The data processing system of claim 47, wherein the program code, when executed, further causes the data processing system to perform:
determining and recording a difference in a value of the selected metric from a control value due to presence of a test substance in the matrix.

49. The data processing system of claim 29, wherein the cell is taken from a set including cancer cells, leukocytes, stem cells, fibroblasts, natural killer (NK) cells, macrophages, T lymphocytes (CD4⁺ and CD8⁺), B lymphocytes, adult stem cells, dendritic cells, professional Antigen presenting cells (pAPC), neutrophil, basophil and eosinophil granulocytes.

50. The data processing system of claim 49, wherein the cell is a cancer cell taken from a set including commercially available tumor cell lines, modified tumor cell lines, and tumor cells of a patient.

51. The data processing system of claim 50, wherein the cancer cell is from a commercially available tumor cell line taken from a set including PC-3 (prostate carcinoma), MCF-7 (breast carcinoma, ER positive, luminal-like), MDA-MB-468 (breast carcinoma, basal-like), MDA-MB-231 (breast carcinoma, basal-like), HT29 (colon carcinoma), SW480 (colon carcinoma), SW620 (colon carcinoma, metastasis of SW480), MV3 (melanoma), NB4 (myeloid leukaemia), Dohh-2 (B cell leukaemia), Molt-4 (T cell leukaemia), IMIM-PC2 (pancreatic carcinoma), PANC1 (pancreatic carcinoma), CFPAC1 (pancreatic carcinoma), ES-2 (ovarian cancer), T-24 (bladder cancer), HepG2 (hepatocellular carcinoma), A-549 (non-small cell lung cancer, adenocarcinoma), HTB-58 (non-small cell lung cancer, squamous carcinoma), and SCC4 (tongue squamous carcinoma).

52. The data processing system of claim 51, wherein the cancer cell is from a tumor cell line in a NCI 60 panel.

53. The data processing system of claim 49, wherein:
the cell is taken from tumor cells of a patient;
the matrix includes a test substance; and
wherein the program code, when executed, further causes the data processing system to perform:
automatically determining, based on the image, a selected metric for the cell among a set including a motility metric, a frequency metric and a morphology metric;
automatically determining, based on the selected metric, probability of success of therapy on the patient employing the test substance and reporting the probability of success.

54. The data processing system of claim 53, wherein:
the cell is taken from tumor cells of a patient;
the matrix includes a test substance; and
wherein the program code, when executed, further causes the data processing system to perform:
automatically determining, based on the image, a selected metric for the cell among a set including a motility metric, a frequency metric and a morphology metric;
and
automatically selecting a treatment plan for recommendation based on the selected metric and reporting the recommended treatment plan.

55. A data processing system comprising:
a processor;
data storage coupled to the processor, wherein the data storage includes program code that, when executed by the processor, causes the data processing system to perform:
automatically determining, based on image processing of a plurality of images captured from a matrix including living cells of a patient and a test substance, one or more metrics for the living cells among a set including a motility metric, a frequency metric and a morphology metric; and
automatically determining, based on the one or more metrics, a probability of success of a therapy on the patient employing the test substance and reporting the probability of success.

56. A data processing system comprising:
a processor;
data storage coupled to the processor, wherein the data storage includes program code that, when executed by the processor, causes the data processing system to perform:
automatically determining, based on image processing of a plurality of images captured from a matrix including living cells of a patient and a test substance, one or more metrics for the living cells among a set including a motility metric, a frequency metric and a morphology metric; and
automatically selecting a treatment plan for recommendation based on the one or more metrics and reporting the recommended treatment plan.

57. An apparatus, comprising:
a data processing system in accordance with claim 29; and
a microscope communicatively coupled to the data processing system.

58. The apparatus of claim 57, wherein the microscope includes a multi-focal plane digital camera.

59. A program product, comprising:
a data processing system-readable storage device;
program code stored in the data processing system-readable medium that, when executed, causes a data processing system to perform:
receiving an image of a matrix including a plurality of living cells;
automatically locating a cell among the plurality of living cells in the image by performing image processing on the image; and
in response to locating the cell, recording a position of the cell in the image.

60. The data processing system of claim 59, wherein receiving the image comprises receiving the image in a video sequence of a plurality of images having a common focal plane within the matrix.

61. The data processing system of claim 60, wherein the program code, when executed, further causes the data processing system to perform:
building a data structure that time-orders the plurality of images.

62. The data processing system of claim 61, wherein the building includes building a plurality of data structures including the data structure, wherein each of the plurality of data structures corresponds to a respective one of a corresponding plurality of focal planes within the matrix.

63. The data processing system of claim 60, wherein the program code, when executed, further causes the data processing system to perform:
building a data structure that contains per-cell data for each of the plurality of images captured at the common focal plane.

64. The data processing system of claim 60, wherein:
the image is a reference image of the video sequence and the position is a first position;
the video sequence includes a subsequent image captured subsequent to the reference image; and
wherein the program code, when executed, further causes the data processing system to perform automatically locating the cell at a subsequent position in the subsequent image and recording, in the data storage, the second position in association with the cell.

65. The data processing system of claim 64, wherein automatically locating the cell at the subsequent position includes convolving a blob representing the cell with a sample region of the subsequent image.

66. The data processing system of claim 64, wherein the program code, when executed, further causes the data processing system to perform:
locating others of the plurality of cells in the subsequent image after locating the cell in the subsequent image.

67. The data processing system of claim 59, wherein the locating includes preparing a thresholded sharpened image from the received image and searching for the cell in the thresholded sharpened image.

68. The data processing system of claim 59, wherein the locating includes:
locating multiple of the plurality of cells in the image by separately searching for cells that are nearly in-focus and cells that are in-focus.

69. The data processing system of claim 59, wherein the locating includes:
identifying a prospective cell location by convolving a sample region with a spatial filter; and
validating the prospective cell location by determining that a convolution energy computed by convolving an edge pulse with multiple radial sample vectors centered on the prospective cell location satisfies a threshold.

70. The data processing system of claim 59, wherein:
the matrix is a three-dimensional matrix; and
wherein the program code, when executed, further causes the data processing system to perform controlling an element of a microscope to enable capture of a plurality of images including the image, wherein multiple of the plurality of images are captured at different focal planes.

71. The data processing system of claim 70, wherein multiple of the plurality of images are captured at a same focal plane.

72. The data processing system of claim 59, wherein:
the matrix is a three-dimensional matrix;
the image is a first image captured at a first focal plane within the matrix;
the position is a first position; and
wherein the program code, when executed, further causes the data processing system to perform automatically locating the cell at a second position in a second image captured at a different second focal plane within the matrix and recording, in the data storage, the second position in association with the cell.

73. The data processing system of claim 59, wherein the program code, when executed, further causes the data processing system to perform:
automatically determining and recording a motility metric for the cell based on the position.

74. The data processing system of claim 59, wherein the program code, when executed, further causes the data processing system to perform:
automatically determining and recording a frequency metric for the cell based on the position.

75. The data processing system of claim 59, wherein the program code, when executed, further causes the data processing system to perform:
automatically determining a morphology metric for the cell from the image.

76. The data processing system of claim 75, wherein automatically determining a morphology metric for the cell includes automatically determining a morphology metric for a subcellular structure of the cell.

77. The data processing system of claim 59, wherein the program code, when executed, further causes the data processing system to perform:
automatically determining, based on the image, a selected metric for the cell among a set including a motility metric, a frequency metric and a morphology metric.

78. The data processing system of claim 77, wherein the program code, when executed, further causes the data processing system to perform:
determining and recording a difference in a value of the selected metric from a control value due to presence of a test substance in the matrix.

79. The data processing system of claim 59, wherein the cell is taken from a set including cancer cells, leukocytes, stem cells, fibroblasts, natural killer (NK) cells, macrophages, T lymphocytes (CD4⁺ and CD8⁺), B lymphocytes, adult stem cells, dendritic cells, professional Antigen presenting cells (pAPC), neutrophil, basophil and eosinophil granulocytes.

80. The data processing system of claim 79, wherein the cell is a cancer cell taken from a set including commercially available tumor cell lines, modified tumor cell lines, and tumor cells of a patient.

81. The data processing system of claim 80, wherein the cancer cell is from a commercially available tumor cell line taken from a set including PC-3 (prostate carcinoma), MCF-7 (breast carcinoma, ER positive, luminal-like), MDA-MB-468 (breast carcinoma, basal-like), MDA-MB-231 (breast carcinoma, basal-like), HT29 (colon carcinoma), SW480 (colon carcinoma), SW620 (colon carcinoma, metastasis of SW480), MV3 (melanoma), NB4 (myeloid leukaemia), Dohh-2 (B cell leukaemia), Molt-4 (T cell leukaemia), IMIM-PC2 (pancreatic carcinoma), PANC1 (pancreatic carcinoma), CFPAC1 (pancreatic carcinoma), ES-2 (ovarian cancer), T-24 (bladder cancer), HepG2 (hepatocellular carcinoma), A-549 (non-small cell lung cancer, adenocarcinoma), HTB-58 (non-small cell lung cancer, squamous carcinoma), and SCC4 (tongue squamous carcinoma).

82. The data processing system of claim 81, wherein the cancer cell is from a tumor cell line in a NCI 60 panel.

83. The data processing system of claim 79, wherein:
the cell is taken from tumor cells of a patient;
the matrix includes a test substance; and
wherein the program code, when executed, further causes the data processing system to perform:
automatically determining, based on the image, a selected metric for the cell among a set including a motility metric, a frequency metric and a morphology metric;
automatically determining, based on the selected metric, probability of success of therapy on the patient employing the test substance and reporting the probability of success.

84. The data processing system of claim 83, wherein:
the cell is taken from tumor cells of a patient;
the matrix includes a test substance; and
wherein the program code, when executed, further causes the data processing system to perform:
automatically determining, based on the image, a selected metric for the cell among a set including a motility metric, a frequency metric and a morphology metric;
and
automatically selecting a treatment plan for recommendation based on the selected metric and reporting the recommended treatment plan.

85. A program product comprising:
a data processing system-readable storage device;
program code stored in the data processing system-readable medium that, when executed, causes a data processing system to perform:
automatically determining, based on image processing of a plurality of images captured from a matrix including living cells of a patient and a test substance, one or more metrics for the living cells among a set including a motility metric, a frequency metric and a morphology metric; and
automatically determining, based on the one or more metrics, a probability of success of a therapy on the patient employing the test substance and reporting the probability of success.

86. A program product comprising:
a data processing system-readable storage device;
program code stored in the data processing system-readable medium that, when executed, causes a data processing system to perform:
automatically determining, based on image processing of a plurality of images captured from a matrix including living cells of a patient and a test substance, one or more metrics for the living cells among a set including a motility metric, a frequency metric and a morphology metric; and
automatically selecting a treatment plan for recommendation based on the one or more metrics and reporting the recommended treatment plan.
